(19) United States
(12) Patent Application Publication
(10) Pub. No.: US 2026/0341230 A1
(43) Pub. Date: Oct. 29, 2026

(54) DISPLAY PANEL AND DISPLAY DEVICE INCLUDING THE SAME

(71) Applicant: LG DISPLAY CO., LTD., Seoul (KR)

(72) Inventor: Boo Heung LEE, Paju-si (KR)

(73) Assignee: LG DISPLAY CO., LTD., Seoul (KR)

(21) Appl. No.: 19/657,944

(22) Filed: Apr. 24, 2026

(30) Foreign Application Priority Data
Apr. 29, 2025 (KR) 10-2025-0056428

(51) Int. Cl. G09G 3/3266; G09G 3/32

(52) U.S. Cl. CPC G09G 3/3266; G09G 3/32; G09G 2310/0245; G09G 2310/0267; G09G 2310/0286; G09G 2330/021

(57) ABSTRACT

A display panel includes: a display area in which a plurality of data lines, a plurality of gate lines, a plurality of power lines, and a plurality of sub-pixels are disposed; and a gate driver connected to the gate lines. The gate driver includes a rendering signal generator sequentially outputting a rendering signal; a gate signal output circuit sequentially outputting a gate signal; and an output controller receiving the rendering signal, the gate signal, and a frequency control signal to output a pulse of the gate signal to a corresponding gate line or maintain a voltage of the corresponding gate line at a first gate voltage. A display device is also disclosed.

### CROSS-REFERENCE TO RELATED APPLICATION

This application claims the benefit of and priority to Korean Patent Application No. 10-2025-0056428, filed Apr. 29, 2025, the entire contents of which are incorporated herein by reference for all purposes.

### BACKGROUND

### 1. Technical Field

The present disclosure relates to a display panel and a display device including the same.

### 2. Description of Related Art

An electroluminescent display device includes self-emissive light-emitting elements, such as organic light emitting diodes (OLEDs), arranged in respective sub-pixels. The device provides a fast response speed, high luminous efficiency, high luminance, and a wide viewing angle. In addition, the device can represent black gradation as complete black, and thus improves contrast ratio and color reproduction.

The electroluminescent display device does not require a backlight unit and may be formed on a plastic substrate, a thin glass substrate, and/or a metal substrate that include flexible materials.

Various approaches have been investigated to further reduce power consumption of electroluminescent display devices. For example, Variable Refresh Rate (VRR) technology may be applied to the electroluminescent display device. However, implementation of VRR technology may increase the size and complexity of a gate driving circuit, which can reduce display panel yield and increase a non-display area of the display panel.

The description of related art should not be considered prior art merely because it is mentioned in or associated with this section. The description of related art includes information that describes one or more aspects of the subject technology, and the description in this section does not limit the scope of the present disclosure.

### SUMMARY

The present disclosure is directed to overcoming limitations and disadvantages of the related art, including the problems described above.

One or more aspects of the present disclosure are directed to providing a display panel capable of reducing power consumption and a display device including the same.

Other aspects, features and advantages of the present disclosure are set forth in the present disclosure and will also be apparent from the present disclosure or may be learned by practice of the inventive concepts provided herein.

A display panel according to one or more example embodiments includes: a display area in which a plurality of data lines, a plurality of gate lines, a plurality of power lines, and a plurality of sub-pixels are disposed; and a gate driver connected to the plurality of gate lines. The gate driver includes: a rendering signal generator configured to sequentially output a rendering signal; a gate signal output circuit configured to sequentially output a gate signal; and an output controller configured to receive the rendering signal, the gate signal, and a frequency control signal to output a pulse of the gate signal to a corresponding gate line or to maintain a voltage of the corresponding gate line at a first gate voltage.

The gate signal output circuit may include a plurality of signal transfer stages connected to one or more clock wires to which one or more clock signals are applied, the plurality of signal transfer stages sequentially connected through a carry signal wire that propagates a carry signal from a preceding stage to a succeeding stage among the plurality of signal transfer stages, each of the plurality of signal transfer stages configured to output a corresponding gate signal to a corresponding first output node. The output controller may include a plurality of controllers, each connected to a corresponding one of the plurality of signal transfer stages of the gate signal output circuit, each of the plurality of controllers configured to receive the corresponding gate signal from a corresponding signal transfer stage, receive the frequency control signal, and output a corresponding final gate signal to a corresponding second output node connected to a respective gate line. The corresponding final gate signal may include a pulse of the corresponding gate signal or a signal maintained at the first gate voltage.

The gate signal output circuit may include: a first signal transfer stage configured to output a pulse of a first gate signal; and a second signal transfer stage configured to receive the pulse of the first gate signal as a carry signal and output a pulse of a second gate signal following the pulse of the first gate signal. The output controller may include: a first controller configured to receive the pulse of the first gate signal, a pulse of a first rendering signal, and the frequency control signal; and a second controller configured to receive the pulse of the second gate signal, a pulse of a second rendering signal generated following the pulse of the first rendering signal, and the frequency control signal.

An N-th (N is a natural number) signal transfer stage may output an N-th gate signal to a first output node in response to a voltage of a Q node. An N-th controller may share the Q node and output an N-th final gate signal to a second output node in response to an N-th rendering signal, the N-th gate signal, and the frequency control signal.

The N-th signal transfer stage may include: a first transistor including a gate electrode connected to a clock node to which a clock signal is applied, a first electrode connected to a VST node to which a start signal or a carry signal is input, and a second electrode connected to a Q2 node; a second transistor including a gate electrode connected to the VST node, a first electrode connected to a buffer node, and a second electrode connected to a VEH node to which a second gate voltage is applied; a first capacitor between the buffer node and the clock node; a third transistor including a gate electrode connected to the buffer node, a first electrode connected to the clock node, and a second electrode connected to a QB node; a fourth transistor including a gate electrode connected to the Q2 node, a first electrode connected to the QB node, and a second electrode connected to the VEH node; a fifth transistor including a gate electrode connected to a VEL node to which the first gate voltage is applied, a first electrode connected to the Q2 node, and a second electrode connected to the Q node; a sixth-first transistor including a gate electrode connected to the Q node, a first electrode connected to the VEL node, and a second electrode connected to the first output node; a second capacitor connected between the Q node and the first output node; a seventh transistor including a gate electrode connected to the QB node, a first electrode connected to the first output node, and a second electrode connected to the VEH node; and a third capacitor connected between the QB node and the VEH node.

The N-th controller may further include: a sixth-second transistor including a gate electrode connected to the Q node, a first electrode connected to the VEL node, and a second electrode connected to the second output node; a fourth capacitor in which a voltage of the frequency control signal is charged; an eighth transistor including a gate electrode to which the N-th rendering signal is applied, a first electrode connected to the fourth capacitor, and a second electrode to which the frequency control signal is applied; and a ninth transistor including a gate electrode connected to the fourth capacitor, a first electrode connected to the first output node, and a second electrode connected to the second output node.

The N-th controller may include: a first control transistor including a gate electrode connected to the Q node, a first electrode connected to a VEL node to which the first gate voltage is applied, and a second electrode connected to the second output node; a capacitor in which a voltage of the frequency control signal is charged; a second control transistor including a gate electrode to which the N-th rendering signal is applied, a first electrode connected to the capacitor, and a second electrode to which the frequency control signal is applied; and a third control transistor including a gate electrode connected to the capacitor, a first electrode connected to the first output node, and a second electrode connected to the second output node.

Each of the sub-pixels may include: a light-emitting device; a driving circuit configured to drive the light-emitting device; a capacitor connected to the driving circuit; and one or more switch circuits connected to the capacitor.

Each of the one or more switch circuits may include a transistor. The first gate voltage or the pulse of the gate signal output from the output controller may be applied to the corresponding gate line. The corresponding gate line may be connected to a gate electrode of the transistor.

Each of the plurality of sub-pixels may include: a driving transistor including a gate electrode connected to a first node, a first electrode connected to a second node, and a second electrode connected to a third node; a light-emitting device including an anode electrode connected to a fourth node and a cathode electrode to which a cathode voltage is applied; a capacitor connected between a node to which a pixel driving voltage is applied and the first node; a first switch transistor including a gate electrode to which a first gate signal is applied, a first electrode connected to the first node, and a second electrode connected to the third node; a second switch transistor including a gate electrode to which a second gate signal is applied, a first electrode connected to a data line, and a second electrode connected to the second node; a third switch transistor including a gate electrode to which a fifth gate signal is applied, a first electrode connected to the node to which the pixel driving voltage is applied, and a second electrode connected to the second node; a fourth switch transistor including a gate electrode to which the fifth gate signal is applied, a first electrode connected to the third node, and a second electrode connected to the fourth node; and a fifth switch transistor including a gate electrode to which a fourth gate signal is applied, a first electrode connected to the first node, and a second electrode to which an initialization voltage is applied. The pulse of the gate signal output from the output controller or the first gate voltage may be at least one of the first gate signal and the fourth gate signal.

Each of the plurality of sub-pixels may further include: a sixth switch transistor including a gate electrode to which a third gate signal is applied, a first electrode connected to the fourth node, and a second electrode to which an anode reset voltage is applied; and a seventh switch transistor including a gate electrode to which the third gate signal is applied, a first electrode connected to the second node, and a second electrode to which an on bias voltage is applied.

A display device according to one or more example embodiments includes: a display panel including a display area in which a plurality of data lines, a plurality of gate lines, a plurality of power lines, and a plurality of sub-pixels are disposed; and a gate driver connected to the gate lines; and a data driver connected to the data lines. The gate driver includes a rendering signal generator configured to sequentially output a rendering signal; a gate signal output circuit configured to sequentially output a gate signal; and an output controller configured to receive the rendering signal, the gate signal, and a frequency control signal to output a pulse of the gate signal to a corresponding gate line or maintain a voltage of the corresponding gate line at a first gate voltage. Each of first sub-pixels to which the pulse of the gate signal is applied from the output controller is charged with a data voltage from the data driver to update pixel data. Each of second sub-pixels to which the voltage maintained at the first gate voltage is applied from the output controller is driven with a previously charged data voltage. The plurality of sub-pixels include the first sub-pixels and the second sub-pixels.

The display panel may include: a refresh pixel area in which pixel data is updated in one frame period, and a skip pixel area in which pixel data is not updated. The refresh pixel area may include the first sub-pixels to which the pulse of the gate signal is applied from the output controller. The skip pixel area may include the second sub-pixels to which the voltage maintained at the first gate voltage is applied from the output controller.

A display device according to one or more example embodiments includes: a display area including a plurality of gate lines and a plurality of sub-pixels; and one or more controllers configured to control the plurality of sub-pixels to selectively assign refresh sub-pixels and skip sub-pixels among the plurality of sub-pixels. Pixel data of the refresh sub-pixels is updated during a frame period, and pixel data of the skip sub-pixels is not updated during the frame period. The one or more controllers include a gate driver connected to the plurality of gate lines. The gate driver is configured to: output a pulse of a first gate signal to a first gate line corresponding to the refresh sub-pixels based on a first rendering signal, the first gate signal, and a frequency control signal; and maintain a second gate line corresponding to the skip sub-pixels at a first gate voltage based on a second rendering signal and the frequency control signal.

Sub-pixels selectively assigned as refresh sub-pixels at a first time point may differ from sub-pixels selectively assigned as refresh sub-pixels at a second time point. Sub-pixels selectively assigned as skip sub-pixels at the first time point may differ from sub-pixels selectively assigned as skip sub-pixels at the second time point. During operation of the display device, the first time point may precede a given frame period, and the second time point may follow the given frame period.

The gate driver may include a rendering signal generator, a gate signal output circuit, and an output controller.

The rendering signal generator may include a first transfer stage and a second transfer stage. The first transfer stage may be configured to output the first rendering signal, and the second transfer stage may be configured to receive the first rendering signal as a carry signal and to output the second rendering signal.

The gate signal output circuit may include a first signal transfer stage and a second signal transfer stage. The first signal transfer stage may be configured to output the first gate signal, and the second signal transfer stage may be configured to receive the first gate signal as a carry signal and to output a second gate signal.

The output controller may include a first controller and a second controller. The first controller may be configured to receive the first rendering signal from the first transfer stage, the first gate signal from the first signal transfer stage, and the frequency control signal, and may output the pulse of the first gate signal to the first gate line corresponding to the refresh sub-pixels. The second controller may be configured to receive the second rendering signal from the second transfer stage and the frequency control signal without receiving the second gate signal from the second signal transfer stage, and may output the first gate voltage to the second gate line corresponding to the skip sub-pixels.

The first transfer stage and the second transfer stage may be connected in cascade, and the first signal transfer stage and the second signal transfer stage may be connected in cascade, while the first controller and the second controller are not connected in cascade.

The first transfer stage may be directly connected to the first controller while the first transfer stage is not directly connected to the first signal transfer stage. The second transfer stage may be directly connected to the second controller while the second transfer stage is not directly connected to the second signal transfer stage.

The one or more controllers may include a timing controller, or may include both a timing controller and a host system.

The one or more controllers may be configured to selectively assign, in real time, refresh sub-pixels and skip sub-pixels among the plurality of sub-pixels.

In one or more aspects, the subject technology may reduce or minimize power consumption by varying a pixel refresh rate according to a position within a display area without degrading image quality, and may enable low-power driving and improved operational lifespan of a display device.

In one or more aspects, the subject technology may reduce power consumption without degrading image quality by displaying images at different refresh rates in different regions of a display panel or by driving different regions of a display panel at different refresh rates.

In one or more aspects, the subject technology may vary a pixel driving frequency without degrading image quality by selectively controlling refresh operations and skip operations (or selectively controlling refresh pixels and skip pixels) in units of pixel lines.

In one or more aspects, the subject technology may result in minimal increase in the size of a non-display area of a display panel due to limited additions of circuits and signal lines used to control a variable refresh rate, and may facilitate a narrow bezel design of the display panel.

The effects of the subject technology are not limited to the effects mentioned above, and other effects not mentioned will be clearly understood by those skilled in the art from the present disclosure.

It is to be understood that both the foregoing description and the following description of the present disclosure are examples, and are intended to provide further explanation of the disclosure as claimed. Nothing in this section should be taken as a limitation on the claims. Further features, advantages, and aspects are discussed below in conjunction with embodiments of the present disclosure.

### BRIEF DESCRIPTION OF THE DRAWINGS

The accompanying drawings, which are included to provide a further understanding of the present disclosure and constitute a part of this disclosure, illustrate example embodiments of the present disclosure and, together with the description, serve to explain principles and examples of the present disclosure. In the drawings:

FIG. 1 is a block diagram showing a display device according to an example embodiment of the present disclosure;

FIGS. 2A and 2B are example views showing a plurality of pixel areas in which a driving frequency of pixels is independently controlled;

FIG. 3 is a circuit diagram showing a pixel circuit according to a first example embodiment of the present disclosure;

FIGS. 4A and 4B are waveform diagrams showing an example of gate signals applied to the pixel circuit shown in FIG. 3 during a refresh period and a skip period;

FIG. 5 is an example of a view showing a gate driver for driving the pixel circuit shown in FIG. 3;

FIG. 6 is an example of a view showing a configuration of a gate driver capable of varying a driving frequency of pixels according to a refresh rate;

FIG. 7 is a circuit diagram showing in detail an example of the gate driver shown in FIG. 6;

FIGS. 8A to 13B are examples of views illustrating an operation of the output controller shown in FIG. 7; and

FIG. 14 is a cross-sectional view showing a cross-sectional structure of a display panel according to an example embodiment of the present disclosure.

### DETAILED DESCRIPTION

Reference is now made in detail to embodiments of the present disclosure, examples of which may be illustrated in the accompanying drawings. In the following description, when a detailed description of well-known methods, functions, structures or configurations may unnecessarily obscure aspects of the present disclosure, the detailed description thereof may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., layers, films, components, electrodes, structures, transistors, sections, members, parts, regions, areas, portions, steps, operations, and/or the like), one or more other elements may be added unless a term such as “only” or the like is used. The terms used in the present disclosure are merely used in order to describe particular example embodiments, and are not intended to limit the scope of the present disclosure. Any references to singular may include plural, and vice versa, unless expressly stated otherwise. In one or more examples, unless expressly stated otherwise, an element may be one or more elements; and an element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., layers, films, components, electrodes, structures, transistors, sections, members, parts, regions, areas, portions, and/or the like) are described using any of the terms such as “on,” “on a top of,” “upon,” “on top of,” “over,” “under,” “above,” “upper,” “below,” “lower,” “beneath,” “near,” “close to,” “adjacent to,” “beside,” “next to,” “at or on a side of,” and/or the like indicating a position or location, one or more other elements may be located between the two elements unless a more limiting term, such as “immediate(ly),” “direct(ly),” or “close(ly),” is used. For example, when an element and another element are described using any of the foregoing terms, this description should be construed as including a case in which the elements contact each other directly as well as a case in which one or more additional elements are disposed or interposed therebetween. Furthermore, the spatially relative terms such as the foregoing terms as well as other terms such as “front,” “rear,” “back,” “left,” “right,” “top,” “bottom,” “upper,” “lower,” “downward,” “upward,” “up,” “down,” “column,” “row,” “vertical,” “horizontal,” “diagonal,” and the like refer to an arbitrary frame of reference. For example, these terms may be used for an example understanding of a relative relationship between elements, including any correlation as shown in the drawings. However, embodiments of the disclosure are not limited thereby or thereto. The spatially relative terms are to be understood as terms including different orientations of the elements in use or in operation in addition to the orientation depicted in the drawings or described herein. For example, where a lower element or an element positioned under another element is overturned, then the element may be termed as an upper element or an element positioned above another element. Thus, for example, the term “under” or “beneath” may encompass, in meaning, the term “above” or “over.” An example term “below” or the like, can include all directions, including directions of “below,” “above” and diagonal directions. Likewise, an example term “above,” “on” or the like can include all directions, including directions of “above,” “on,” “below” and diagonal directions.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” “A,” “B,” “(a),” “(b),” and the like may be used herein to describe various elements (e.g., layers, films, components, electrodes, structures, transistors, sections, members, parts, regions, areas, portions, steps, operations, and/or the like), these elements should not be limited by these terms, for example, to any particular order, precedence, or number of elements. Further, these are not used to define the essence or basis of the elements. These terms are merely used to refer to one element separately from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

The expression that an element (e.g., layer, film, component, electrode, structure, transistor, section, member, part, region, area, portion, or the like) “is engaged” with another element may be understood, for example, as that the element may be either directly or indirectly engaged with the another element. The term “is engaged” or similar expressions may refer to a term such as “is in contact,” “contacts,” “overlaps,” “crosses,” “intersects,” “is connected,” “is coupled,” “is combined,” “is linked,” “is provided,” “is disposed,” “interacts,” or the like. The engagement may involve one or more intervening elements disposed or interposed between the element and the another element, unless otherwise specified. Further, the element may be engaged at least partially or entirely (or completely) with the another element, unless otherwise specified. Further, the element may be included in at least one of two or more elements that are engaged with each other. Similarly, the another element may be included in at least one of two or more elements that are engaged with each other. When the element is engaged with the another element, at least a portion of the element may be engaged with at least a portion of the another element. The term “with another element” or similar expressions may be understood as “another element,” or “with, to, in, or on another element,” as appropriate by the context. Similarly, the term “with each other” may be understood as “each other,” or “with, to, or on each other,” as appropriate by the context.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally. For example, the terms “first direction,” “second direction,” and the like should not be interpreted only based on a geometrical relationship in which the respective directions are parallel, perpendicular, diagonal, or slanted with respect to each other, and may be meant as directions having wider directivities within the range within which the components of the present disclosure may operate functionally.

The term “at least one” should be understood as including any and all combinations of one or more of the associated listed items. For example, unless stated otherwise, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, unless stated otherwise, at least one of a plurality of elements can represent (i) one element of the plurality of elements, (ii) some elements of the plurality of elements, or (iii) all elements of the plurality of elements. Further, unless stated otherwise, “at least some,” “some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) one or more elements of the plurality of elements, (v) multiple elements of the plurality of elements, or (vi) all of the plurality of elements. Moreover, unless stated otherwise, “at least some,” “some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, (iii) the element, or (iv) all portions of the element.

The expression of a first element, a second elements “and/or” a third element should be understood as any one of the first, second and third elements or as any or all combinations of the first, second and third elements. Similar interpretations apply to the use of “and/or” with two elements or with more than three elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise. In one or more aspects, unless stated otherwise, the term “nth” may refer to “nnd” (e.g., 2nd where n is 2), or “nrd” (e.g., 3rd where n is 3), and n may be a natural number or a whole number.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” or “nearly the same” may indicate a degree of being considered as being equivalent to each other taking into account minute differences due to errors in the manufacturing process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

Unless otherwise defined, the terms (including technical and scientific terms) used herein have the same meaning as commonly understood by one of ordinary skill in the art to which example embodiments belong. It is further understood that terms, such as those defined in commonly used dictionaries, should be interpreted as having a meaning that is, for example, consistent with their meaning in the context of the relevant art and should not be interpreted in an idealized or overly formal sense unless expressly defined otherwise herein. For example, unless stated otherwise, the term “part,” “unit,” or “module” may refer to, for example, a circuit, a component, an integrated circuit, a computational block of a circuit device, or a structure configured to perform a described function, as would be understood by one of ordinary skill in the art.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same or similar elements may be illustrated in other drawings, and like reference numerals may refer to like or similar elements unless stated otherwise. The same or similar elements may be denoted by the same reference numerals even if they are depicted in different drawings. For brevity, repetitive descriptions of the same or similar elements may be omitted. Elements designated by the same or similar reference numerals in different figures are to be understood as having the same descriptions unless stated otherwise. In addition, for the convenience of description, a scale, dimension, size, and thickness of each of the elements illustrated in the accompanying drawings may be different from an actual scale, dimension, size, and thickness, and thus, embodiments of the present disclosure are not limited to a scale, dimension, size, and thickness illustrated in the drawings.

In description of flow of a signal, for example, when a signal is provided (e.g., transferred or transmitted) from a node A to a node B, this may include a case where the signal is provided from the node A to the node B via one or more nodes unless a phrase such as “immediately provided,” “directly provided” or the like is used.

Each of a pixel circuit and a gate drive circuit of a display device may include a plurality of transistors. A transistor may be implemented as a thin film transistor (TFT). The transistors may be implemented as an oxide thin film transistor (Oxide TFT) including an oxide semiconductor, a low temperature poly silicon TFT (LTPS TFT) including a low temperature poly silicon, and the like.

A transistor is a three-electrode device including a gate, a source, and a drain. The source is an electrode that supplies carriers to the transistor, and the drain is an electrode through which carriers exit the transistor. Accordingly, carriers flow between the source and the drain during operation. In an n-channel transistor, the carriers are electrons. The source is at a lower electrical potential (or voltage) than the drain so that electrons flow from the source to the drain, while conventional current flows from the drain to the source. In a p-channel transistor, such as a p-channel transistor (e.g., a p-channel metal-oxide semiconductor), the carriers are holes. The source is at a higher electrical potential (or voltage) than the drain so that holes flow from the source to the drain, and conventional current flows from the source to the drain.

The designation of source and drain terminals is not fixed and may change depending on applied voltages and operating conditions. Accordingly, the present disclosure is not limited by the labeling of the source and drain terminals. In the example embodiments of the present disclosure, the source electrode and the drain electrode are distinguished for convenience of description and may be interchanged. That is, an electrode described as a source electrode may function as a drain electrode, and vice versa. In the following description, the source and drain of a transistor may also be referred to as a first electrode and a second electrode.

A gate signal swings between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

Hereinafter, various embodiments of the present disclosure will be described in detail with reference to the accompanying drawings.

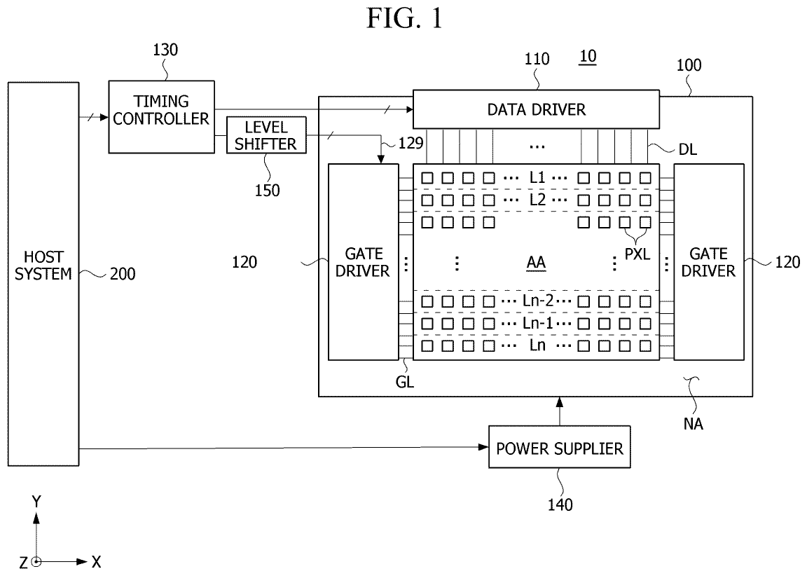

FIG. 1 is a block diagram showing a display device according to an example embodiment of the present disclosure.

Referring to FIG. 1, the display device 10 according to the example embodiment of the present disclosure includes a display panel 100, a display panel driving circuit that is provided to write data to pixels of the display panel 100, and a power supply 140 that generates power necessary for driving the pixels and the display panel driving circuit.

The display panel 100 may include a display area AA where an input image is displayed on a screen. A non-display area NA may be disposed outside the display area AA. A substrate of the display panel 100 may be a plastic substrate, a thin glass substrate, or a metal substrate, but is not limited thereto. The non-display area NA outside the display area AA may be understood as a bezel area. The display panel 100 may be a rectangular panel having a length in the X-axis direction (or first direction), a width in the Y-axis direction (or second direction), and a thickness in the Z-axis direction (or third direction), but is not limited thereto. For example, at least a part of the display panel 100 may have a curved outer portion.

The display panel 100 includes wires such as a plurality of data lines DL, a plurality of gate lines GL intersecting the data lines DL, and a plurality of power lines. The gate lines GL may be disposed on the display panel 100 in parallel to the first direction X, and the data lines DL may be disposed on the display panel 100 in parallel to the second direction Y. Pixels PXL of the display area AA are connected to the data lines DL, the gate lines GL, the power lines, and the like. The power lines may be connected in common to the pixels PXL and supply a constant voltage necessary for driving the pixels PXL to the pixels PXL. The power lines may be implemented on the display panel 100 as long stripe wires along the first direction or the second direction or may be implemented as mesh wires in which wires in the first direction and wires in the second directions are electrically connected.

The display area AA includes a plurality of pixel lines L1 to Ln. Each of the pixel lines L1 to Ln includes one line of sub-pixels disposed along the first direction X of the display panel 100. Pixels disposed in one pixel line may share the gate lines GL. Sub-pixels in one column disposed along the second direction Y share the same data line DL. One horizontal period 1 H is a time obtained by dividing one frame period by the total number of pixel lines L1 to Ln.

The display panel 100 may be implemented as a non-transmissive display panel or a transmissive display panel. The transmissive display panel may be applied to a transparent display device in which an image is displayed on a screen and a real object in a background is visible. The display panel 100 may be manufactured as a flexible display panel. A screen of a foldable display may be implemented as a flexible display panel. The flexible display panel may be folded around a foldable axis across the display area AA. The foldable axis may be present in the display area AA and a gate driver 120 of the flexible display panel along the first direction X, but is not limited thereto.

Each of the pixels PXL may be divided into a red sub-pixel, a green sub-pixel, and a blue sub-pixel for color implementation. Each of the pixels may further include a white sub-pixel. Each of the sub-pixels may include a pixel circuit that is provided to drive a light-emitting element. Each pixel circuit may be connected to the data line, the gate lines, and the power lines. Hereinafter, a “pixel” may be understood as a “sub-pixel.” Each of the sub-pixels includes a pixel circuit that drives a light-emitting element such as an OLED.

The display panel driving circuit may include a data driver 110, a gate driver 120, a timing controller 130, a power supply 140, and a level shifter 150. The driving circuit of the display panel 100 may further include a touch sensor driver. The data driver 110 and the touch sensor driver may be integrated into one drive integrated circuit (IC). In a mobile terminal or a wearable terminal, the timing controller 130, the power supply 140, the level shifter 150, the data driver 110, the touch sensor driver, and the like may be integrated into one drive IC.

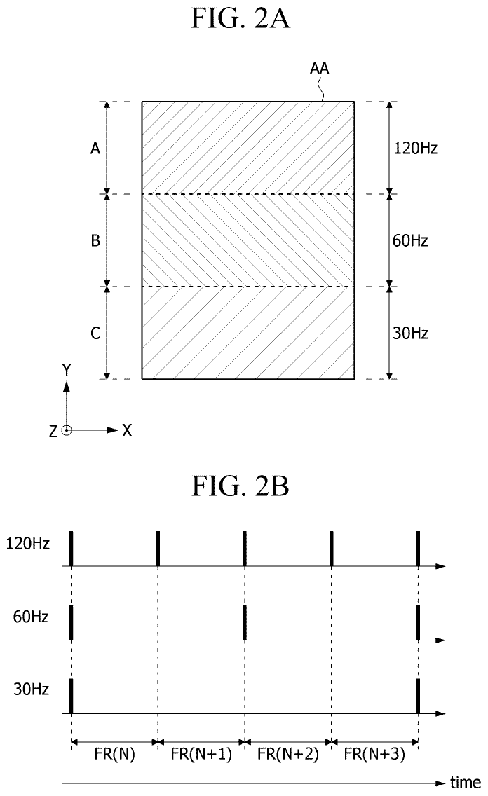

The display panel driving circuit may drive the pixels PXL at a variable refresh rate (VRR) under the control of the timing controller 130. For example, the timing controller 130 may analyze an input image and lower the refresh rate when the input image is not changed for a predetermined (or preset) time, thereby reducing the power consumption of the display device. In this case, the driving circuit of the display panel 100 may control a data writing cycle of the pixels PXL to be longer by lowering the refresh rate of the pixels PXL when a still image is input for a given time or longer under the control of the timing controller 130, thereby reducing the power consumption of the display device. The refresh rate of the driving circuit of the display panel may be lowered when the display device operates in a standby mode or in response to a user's command. Further, the refresh rate may be lowered on an always on display (AOD) screen. The AOD screen is a partial pixel area of the display area AA where preset information, for example, brief information such as a remaining amount of battery power and time is displayed in the standby mode. In one or more aspects, a refresh rate may represent a driving frequency at which data of pixels PXL are updated. As shown in FIGS. 2A and 2B, the display panel driving circuit may vary the refresh rate for different regions (e.g., divided pixel areas) within the display panel, thereby reducing power consumption without degrading image quality.

The timing controller 130 transmits pixel data of the input image to the data driver 110. The timing controller 130 may synchronize the data driver 110 and the gate driver 120 on the basis of a timing signal that is received in synchronization with the input image and control an operation timing of each of the data driver 110 and the gate driver 120. The timing signal may include a vertical synchronization signal Vsync, a horizontal synchronization signal Hsync, a main clock CLK, a data enable signal DE, and the like. One cycle of the vertical synchronization signal Vsync may be one frame period. One cycle of the horizontal synchronization signal Hsync and the data enable signal DE may be one horizontal period 1 H. The data enable signal DE defines a valid data interval of the input image. Because the frame period and the horizontal period can be determined by counting the data enable signal DE, the vertical synchronization signal Vsync and the horizontal synchronization signal Hsync may be omitted.

A gate timing control signal generated from the timing controller 130 may be input to the gate driver 120 through the level shifter 150. The level shifter 150 receives the gate timing control signal and outputs a start signal, a clock signal, and a frequency control signal. An input signal of the level shifter 150 is a signal having a digital signal voltage level, and an output signal of the level shifter 150 may be an analog voltage signal swinging between a gate high voltage and a gate low voltage. The level shifter 150 may convert a low-level voltage of the gate timing signal output from the timing controller 130 to a gate low voltage and convert a high-level voltage to a gate high voltage. Output signals of the level shifter 150 are input to the gate driver 120.

The timing controller 130 controls the display panel driving circuit to lower a driving frequency of the pixels PXL displaying a still image by comparing pixel data between frames of the input image. In another example embodiment, the host system 200 transmits pixel area information indicating a pixel area having a low refresh rate to the timing controller 130, and the timing controller 130 may control the display panel driving circuit to lower a driving frequency of pixels in which a still image is displayed in response to the pixel area information.

An output signal of the level shifter 150 may be input to the gate driver 120 through signal wires 129. The signal wires 129 may include clock wires through which a start signal and a clock signal are transmitted, and a wire through which a frequency control signal is transmitted.

The data driver 110 may receive pixel data of an input image received as digital signals from the timing controller 130 and output a data voltage. The data driver 110 may convert video data of the input image into gamma compensation voltages using digital-to-analog converters (hereinafter, referred to as “DACs”) and output a data voltage. A gamma reference voltage GMA output from the power supplier 140 may be divided into gamma compensation voltages for each gray level through a voltage dividing circuit of the data driver 110 and provided to the DAC. The DAC may output a data voltage as a gamma compensation voltage corresponding to a gray level value of the pixel data. The data voltage output from the DAC may be output to the data line DL through an output buffer in each of the data output channels of the data driver 110.

The gate driver 120 may be disposed on the display panel 100. The gate driver 120 may be disposed in a non-display area NA outside the display area AA in the display panel 100, or at least a portion thereof may be disposed in the display area AA. The gate driver 120 may supply a gate signal to the gate lines GL in a single feeding method or a double feeding method. In single feeding, a gate signal may be applied at one end of the gate line GL. In the double feeding method, the gate signal may be simultaneously applied at both ends of the gate line GL.

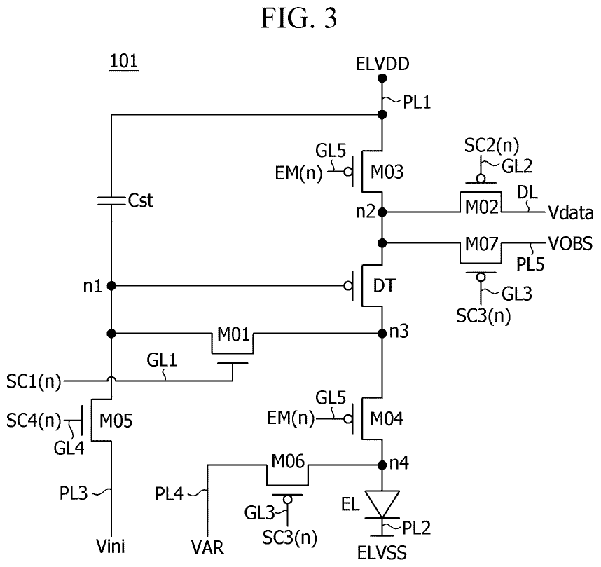

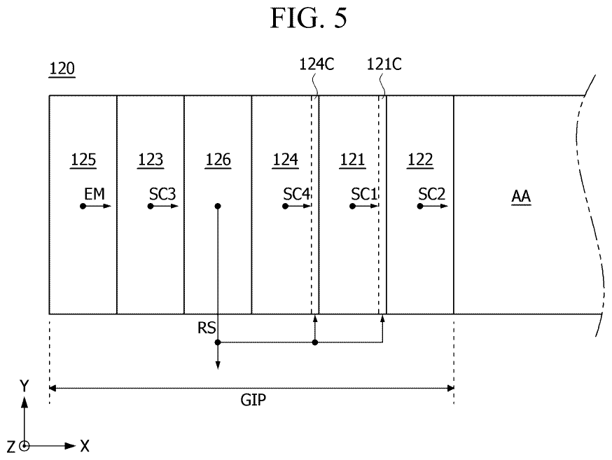

The gate driver 120 may include one or more shift registers and/or edge triggers. As in the pixel circuit shown in FIG. 3, gate signals having different waveforms may be applied to the pixels PXL. In this case, as shown in FIG. 5, the gate driver 120 may include a plurality of gate drivers outputting gate signals having different waveforms. The gate driver 120 may control each of the pixel lines L1 to LN as a pixel line in a pixel area having a high refresh rate or a pixel line in a pixel area having a low refresh rate by varying a frequency of a gate signal applied to the gate lines under the control of the timing controller 130.

The power supplier 140 may include a charge pump, a regulator, a buck converter, a boost converter, and the like, but embodiments of the present specification are not limited thereto. The power supplier 140 may receive a direct current input voltage from the host system 200 and generate power necessary for driving the driver of the display panel 100 and the display panel 100. The power supplier 140 may output constant voltages (or DC voltages) such as a gamma reference voltage, a gate high voltage, and a gate low voltage. In addition, the power supplier 140 may output constant voltages to be provided to the pixel circuit. The gamma reference voltage GMA may be supplied to the data driver 110. The gate high voltage and the gate low voltage may be supplied to the level shifter 150 and the gate driver 120. The constant voltages input to the pixel circuit may be supplied to the pixels through power lines commonly connected to the pixels PXL.

FIGS. 2A and 2B are example views showing a plurality of pixel areas in which a driving frequency of pixels is independently controlled. In FIG. 2B, FR(N) to FR(N+3) represent N-th (N is a natural number) to N+3th frame periods. In FIG. 2B, thick vertical lines represent a data update period varying according to the refresh rate. It should be noted that the pixel areas A, B, and C shown in FIG. 2A and the refresh rates thereof shown in FIG. 2B are merely examples and are not limited to FIGS. 2A and 2B.

Referring to FIGS. 2A and 2B, the display area AA may be divided into two or more pixel areas A, B, and C in terms of a driving frequency of pixels. Each of the pixel areas A, B, and C may include one or more pixel lines. The timing controller 130 may control the data driver 110 and the gate driver 120 to independently control a driving frequency of the pixels for each pixel area. The timing controller 130 may increase a driving frequency of a pixel area requiring a high scan rate data update, while lowering a driving frequency of a pixel area in which image quality degradation is not visually recognized even when data is updated at a low refresh rate. The driving frequency of the pixel is proportional to the refresh rate. For example, as shown in FIGS. 2A and 2B, a refresh rate of 120 Hz of the first pixel area A may be higher than 60 Hz and 30 Hz of the second and third pixel areas B and C, respectively.

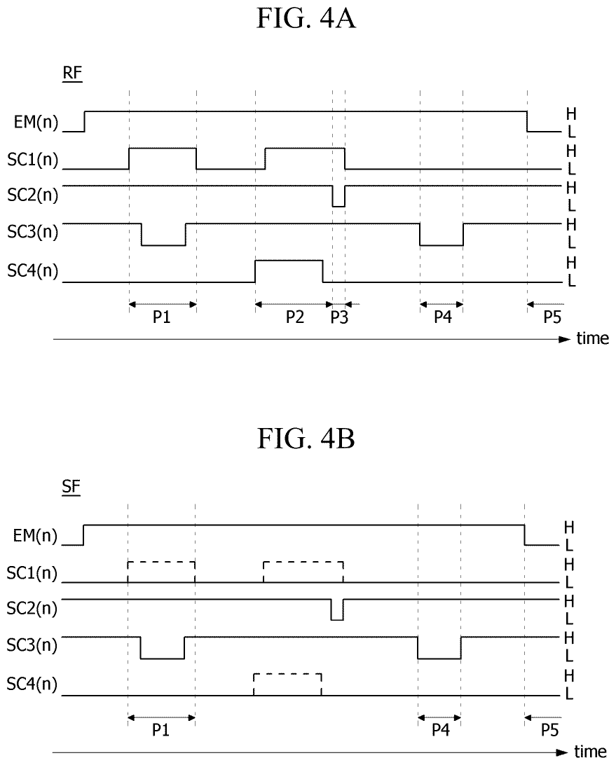

FIG. 3 is a circuit diagram showing a pixel circuit according to an example embodiment of the present disclosure. This pixel circuit may be a pixel circuit of a sub-pixel present in an N-th pixel line. An N-th pixel line may operate as a skip pixel line or a refresh pixel line, depending on the operating conditions of the display panel or in response to one or more control signals of the display panel (e.g., a rendering signal, a gate signal, and a frequency control signal, which are described in more detail later). The pixel circuit of the present disclosure is not limited to FIG. 3. FIGS. 4A and 4B are waveform diagrams showing an example of gate signals applied to the pixel circuit of FIG. 3 during a refresh period RF shown in FIG. 4A and a skip period SF shown in FIG. 4B.

Referring to FIGS. 3, 4A and 4B, the pixel circuit 101 includes a light-emitting element EL, a driving element DT driving the light-emitting element EL, a plurality of switch elements M01 to M07, and a capacitor Cst. Each of the first and fifth switch elements M01 and M05 may be implemented as an n-channel Oxide TFT having a low off-current. The off-current is a leakage current flowing through a semiconductor channel of the transistor in an off state. Each of the second, third, fourth, sixth, and seventh switch elements M02, M03, M04, M06, and M07 and the driving element DT may be implemented as a p-channel LTPS TFT having a high on-current.

The driving element DT generates a current according to a gate-source voltage Vgs to drive the light-emitting element EL. The driving element DT includes a gate electrode connected to a first node n1, a first electrode connected to a second node n2, and a second electrode connected to a third node n3. The light-emitting element EL may be implemented as an OLED, but is not limited thereto. An anode electrode of the light-emitting element EL is connected to a fourth node n4. A cathode voltage ELVSS is applied to a cathode electrode of the light-emitting element EL. The capacitor Cst is connected between a first constant voltage node PL1 to which a pixel driving voltage ELVDD is applied and the first node n1.

The first switch element M01 is connected between the first node n1 and the third node n3. The first switch element M01 may be turned on in response to a gate high voltage (H) of a first gate signal SC1(n). When the first switch element M01 is turned on, the first node n1 is electrically connected to the third node n3. The first switch element M01 includes a gate electrode connected to a first gate line GL1 to which the first gate signal SC1(n) is applied, a first electrode connected to the first node n1, and a second electrode connected to the third node n3.

The second switch element M02 is connected between the data line DL and the second node n2. The second switch element M02 may be turned on in response to a gate low voltage (L) of a second gate signal SC2(n). When the second switch element M02 is turned on, the data line DL to which a data voltage Vdata of the pixel data is applied is electrically connected to the second node n2, and the data voltage Vdata is applied to the second node n2. The second switch element M02 includes a gate electrode connected to a second gate line GL2 to which the second gate signal SC2(n) is applied, a first electrode connected to the data line DL, and a second electrode connected to the second node n2.

The third switch element M03 is connected between a first constant voltage node PL1 to which a pixel driving voltage ELVDD is applied and the second node n2. The third switch element M03 may be turned on in response to a gate low voltage (L) of a fifth gate signal EM(n). When the third switch element M03 is turned on, the first constant voltage node PL1 is electrically connected to the second node n2. The third switch element M03 includes a gate electrode connected to a fifth gate line GL5 to which the fifth gate signal EM(n) is applied, a first electrode connected to the first constant voltage node PL1, and a second electrode connected to the second node n2.

The fourth switch element M04 is connected between the third node n3 and the fourth node n4. The fourth switch element M04 may be turned on in response to a gate low voltage (L) of the fifth gate signal EM(n). When the fourth switch element M04 is turned on, the third node n3 is electrically connected to the fourth node n4. The fourth switch element M04 includes a gate electrode connected to the fifth gate line GL5, a first electrode connected to the third node n3, and a second electrode connected to the fourth node n4.

The fifth switch element M05 is connected between the first node n1 and a third constant voltage node PL3 to which an initialization voltage Vini is applied. The fifth switch element M05 may be turned on in response to a gate high voltage (H) of a fourth gate signal SC4(n). When the fifth switch element M05 is turned on, the first node n1 is electrically connected to the third constant voltage node PL3. The fifth switch element M05 includes a gate electrode connected to a fourth gate line GL4 to which the fourth gate signal SC4(n) is applied, a first electrode connected to the first node n1, and a second electrode connected to the third constant voltage node PL3.

The sixth switch element M06 is connected between the fourth node n4 and a fourth constant voltage node PL4 to which an anode reset voltage VAR is applied. The sixth switch element M06 may be turned on in response to a gate low voltage (L) of a third gate signal SC3(n). When the sixth switch element M06 is turned on, the fourth node n4 is electrically connected to the fourth constant voltage node PL4, and the anode reset voltage VAR is applied to the fourth node n4. The sixth switch element M06 includes a gate electrode connected to a third gate line GL3 to which the third gate signal SC3(n) is applied, a first electrode connected to the fourth node n4, and a second electrode connected to the fourth constant voltage node PL4.

The seventh switch element M07 is connected between the second node n2 and a fifth constant voltage node PL5 to which an on bias voltage VOBS is applied. The seventh switch element M07 may be turned on in response to a gate low voltage (L) of the third gate signal SC3(n). When the seventh switch element M07 is turned on, the on bias voltage VOBS is applied to the second node n2. The seventh switch element M07 includes a gate electrode connected to the third gate line GL3 to which the third gate signal SC3(n) is applied, a first electrode connected to the second node n2, and a second electrode connected to the fifth constant voltage node PL5.

One frame period of the display device may include one or more refresh periods in which pixel data is updated to the pixels, and one or more frame skip periods in which pixel data is not updated to the pixels. A refresh pixel area includes pixels in which pixel data is written by being scanned by a gate signal synchronized with a data voltage during the refresh period. A skip pixel area includes pixels that do not have pixel data written therein during the skip period and maintain a previous data voltage. In the example of FIGS. 2A and 2B, an (N+1)-th frame period FR(N+1) includes a refresh period in which a data voltage is charged to the pixels of the first pixel area A and pixel data is updated, and a skip period in which the second and third pixel areas B and C are driven without data update. An (N+2)-th frame period FR(N+2) includes a refresh period in which the first and second pixel areas A and B are driven, and a skip period in which the third pixel area C is driven.

A refresh period RF shown in FIG. 4A may include a first period P1, a second period P2, a third period P3, a fourth period P4, and a fifth period P5.

During the first period P1, the first switch element M01, the sixth switch element M06, and the seventh switch element M07 are turned on. When the on bias voltage VOBS is applied to the second node n2 in the first period P1, the driving element DT is turned on, and the on bias voltage VOBS is applied to the first node n1 and the second node n2 through the driving element DT and the first switch element M01. At the same time, the anode reset voltage VAR is applied to the fourth node n4 in the first period P1.

During the second period P2, the first switch element M01 and the fifth switch element M05 are turned on. At the end of the second period P2, a threshold voltage of the driving element DT is sampled in the capacitor Cst.

During the third period P3, the first switch element M01 and the second switch element M02 are turned on. Here, the data voltage Vdata is applied to the gate electrode of the driving element DT and the capacitor Cst through the second node n2 and the third node n3, and the data voltage Vdata compensated by the threshold voltage of the driving element DT is stored in the capacitor Cst. During the fourth period P4, the sixth switch element M06 and the seventh switch element M07 are turned on. In the fourth period P4, the on bias voltage VOBS is applied to the second node n2, and at the same time, the anode reset voltage VAR is applied to the fourth node n4. During the fifth period P5, the third switch element M03 and the fourth switch element M04 are turned on, and the light-emitting element EL is driven by a current from the driving element DT, and the light-emitting element EL may emit light with a luminance corresponding to a gray level value of the pixel data.

A skip period SF shown in FIG. 4B includes periods P1 and P4 in which an on bias voltage and an anode reset voltage are applied to the pixel circuit, and a light emission period P5 in which the light-emitting element EL emits light. The data driver 110 stops driving during the skip period and does not output a data voltage. During the skip period, a pulse of the second gate signal SC2(n) may be applied, but since the data voltage Vdata is not output from the data driver 110, the data voltage Vdata is not applied to the pixel circuit. The driving element DT of the pixel circuit may drive the light-emitting element EL by generating a current with a voltage of the capacitor Cst charged with the data voltage Vdata of a previous refresh period.

As described above, the first gate signal SC1(n) and the fourth gate signal SC4(n) control the switch elements M01 and M05 connected to the capacitor Cst. In one or more examples, during the skip period, the first gate signal SC1(n) and the fourth gate signal SC4(n) must maintain a gate off voltage, that is, a gate low voltage (L), so that a voltage of the capacitor Cst does not change.

In one or more aspects, the gate signals SC1(n) to SC4(n) may be referred to as SC1 to SC4, respectively.

FIG. 5 is an example of a view showing a gate driver for driving the pixel circuit shown in FIG. 3. In FIG. 5, “GIP” is a gate driving circuit area present in the non-display area.

Referring to FIGS. 1, 3, and 5, the gate driver 120 may include a first gate driver 121 sequentially outputting a pulse of a first gate signal SC1, a second gate driver 122 sequentially outputting a pulse of a second gate signal SC2, a third gate driver 123 sequentially outputting a pulse of a third gate signal SC3, a fourth gate driver 124 sequentially outputting a pulse of a fourth gate signal SC4, and a fifth gate driver 125 sequentially outputting a pulse of a fifth gate signal EM. The second gate driver 122 may be implemented as a shift register, and the other gate drivers 121, 123, 124, and 125 may be implemented as edge triggers, but they are not limited thereto.

Each of the gate drivers 121 to 125 may receive a start signal and i (i is a natural number of two or more) phase clock signals having different phases. A pulse and a phase of the gate signal may be controlled according to pulses of the start signal and the clock signal.

The gate driver 120 further includes a rendering signal generator 126 and output controllers 121C and 124C to vary a driving frequency of the pixels according to a refresh rate. The rendering signal generator 126 may be implemented as a shift register. The output controllers 121C and 124C include an output controller 121C connected to output nodes of the first gate driver 121, and an output controller 124C connected to output nodes of the fourth gate driver 124.

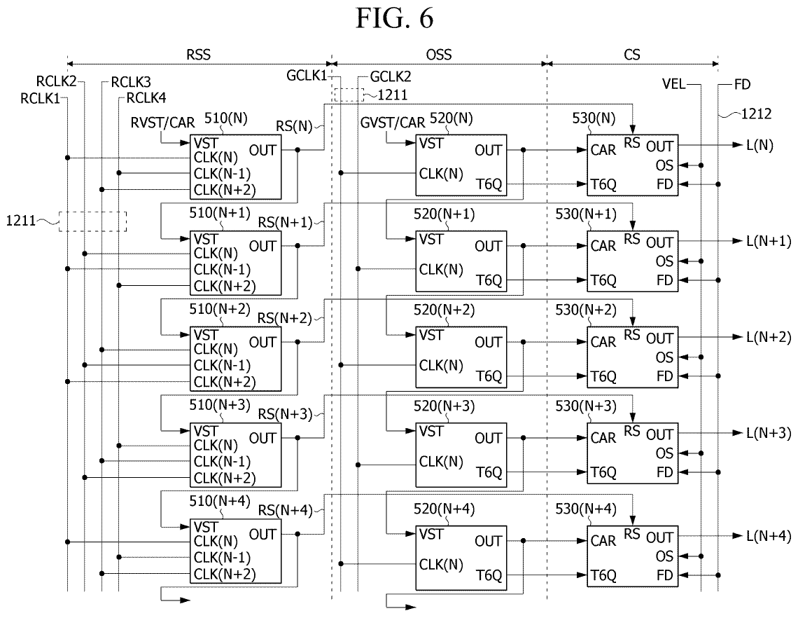

FIG. 6 is an example of a view showing a configuration of a gate driver capable of varying a driving frequency of pixels according to a refresh rate. Each of the first gate driver 121 and the fourth gate driver 124 may be configured as the gate driver shown in FIG. 6. Reference numeral “1211” denotes wires to which clock signals are applied, and “1212” denotes a wire to which a frequency control signal FD is applied. In FIG. 6, L(N) to L(N+4) represent N-th to (N+4)-th pixel lines.

Referring to FIG. 6, each of the first gate driver 121 and the fourth gate driver 124 includes a rendering signal generator RSS, a gate signal output circuit OSS, and an output controller CS. The rendering signal generator RSS is the same as the rendering signal generator 126 shown in FIG. 5, and the output controller CS is the same as the output controllers 121C and 124C shown in FIG. 5. The gate signal output circuit OSS may be the first gate driver 121 or the fourth gate driver 124 shown in FIG. 5.

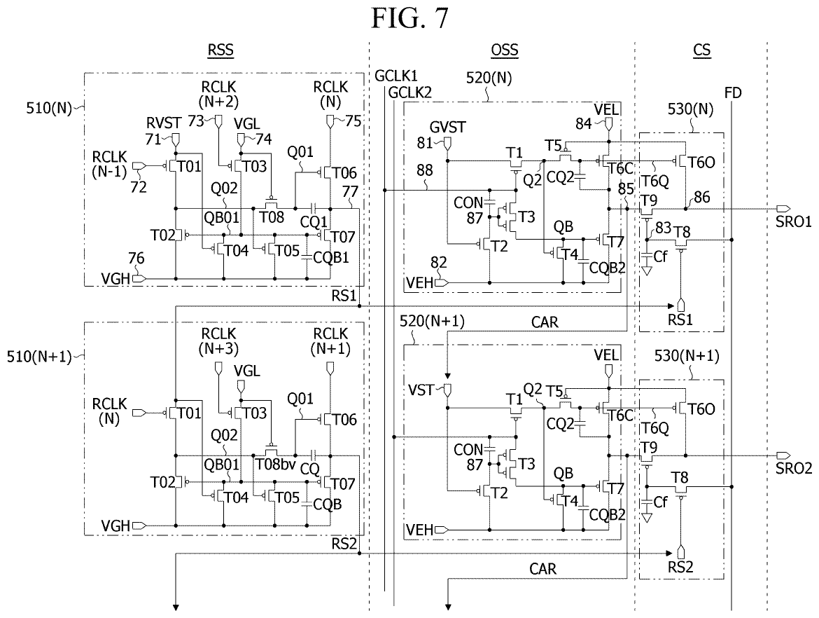

The rendering signal generator RSS includes a plurality of signal transfer stages 510(N) to 510(N+4) dependently connected through clock wires 1121 and a carry signal wire. The rendering signal generator RSS receives a start signal RVST and clock signals RCLK1 to RCLK4 and sequentially outputs pulses of rendering signals RS(N) to RS(N+4). The rendering signal generator 126 may be implemented as a shift register as shown in FIG. 7, but is not limited thereto. Each of the signal transfer stages 510(N) to 510(N+4) includes a VST node to which the start signal RVST or a carry signal CAR is input, clock nodes CLK(N-1), CLK(N), and CLK(N+2) to which corresponding clock signals among the clock signals RCLK1 to RCLK4 are input, and an output node OUT from which the rendering signal RS is output. The start signal RVST is input to a first signal transfer stage. In the example of FIG. 7, the N-th signal transfer stage 510(N) may be the first signal transfer stage to which the start signal RVST is input, but is not limited thereto. In the rendering signal generator RSS, a carry signal input to the VST node of a next signal transfer stage is a rendering signal RS output from a previous signal transfer stage.

The gate signal output circuit OSS includes a plurality of signal transfer stages 520(N) to 520(N+4) dependently connected through clock wires 1121 and a carry signal wire. The gate signal output circuit OSS receives a start signal GVST and clock signals GCLK1 and GCLK2 and sequentially outputs gate signals. The gate signal output circuit OSS may be implemented as an edge trigger as shown in FIG. 7, but is not limited thereto. Each of the signal transfer stages 520(N) to 520(N+4) includes a VST node to which the start signal GVST or a carry signal CAR is input, a clock node CLK(N) to which a clock signal GCLK1 or a clock signal GCLK2 is input, and an output node OUT from which the gate signal is output. The start signal GVST is input to a first signal transfer stage. In the example of FIG. 7, the N-th signal transfer stage 520(N) may be the first signal transfer stage to which the start signal GVST is input, but is not limited thereto. In the gate signal output circuit OSS, a carry signal input to the VST node of a next signal transfer stage is a gate signal output from a previous signal transfer stage (e.g., from an output node OUT of the previous signal transfer stage).

The output controller CS includes a plurality of controllers 530(N) to 530(N+4) connected to output nodes OUT of the corresponding signal transfer stages 520(N) to 520(N+4). Each of the controllers 530(N) to 530(N+4) receives: one rendering signal (which is one of RS(N) to RS(N+4)) input from a corresponding signal transfer stage (which is one of 510(N) to 510(N+4)) of the rendering signal generator RSS; a gate signal input from a corresponding signal transfer stage (which is one of 520(N) to 520(N+4)) of the gate signal output circuit OSS; and a frequency control signal FD.

Each of the controllers 530(N) to 530(N+4) outputs a final gate signal. The final gate signal is output as a pulse of the gate signal or is output as a gate low voltage VEL according to a variable refresh rate or a driving frequency of the pixel PXL. The gate low voltage VEL may be a voltage equal to a gate low voltage that turns off the first and fifth switch elements M01 and M05 of the pixel circuit as shown in FIG. 3.

Each of the controllers 530(N) to 530(N+4) of the output controller CS shares an output node OUT of the corresponding signal transfer stage 520(N) to 520(N+4) to receive the gate signal as a carry signal CAR, and shares a control node T6Q of the corresponding signal transfer stage (which is one of 520(N) to 520(N+4)). Each of the controllers 530(N) to 530(N+4) includes a node OS to which a gate low voltage VEL is applied, a node to which a frequency control signal FD is applied, and an output node OUT from which the final gate signal is output.

FIG. 7 is a circuit diagram showing in detail an example of the gate driver shown in FIG. 6. In FIG. 7, VGL and VEL are gate low voltages and may be understood as a gate off voltage or a first gate voltage for the first and fifth switch elements M01 and M05 of the pixel circuit. VGH and VEH are gate high voltages and may be understood as a gate on voltage or a second gate voltage for the first and fifth switch elements M01 and M05 of the pixel circuit.

Referring to FIG. 7, each of the signal transfer stages 510(N) and 510(N+1) of the rendering signal generator RSS includes a first-first control node (hereinafter referred to as “Q01 node”), a first-second control node (hereinafter referred to as “Q02 node”), a second control node (hereinafter referred to as “QB01 node”), and a plurality of transistors T01 to T08. Each of the transistors T01 to T08 may be implemented as a p-channel LTPS TFT, but is not limited thereto.

The signal transfer stages 510(N) and 510(N+1) may be implemented with substantially the same circuit. The N-th signal transfer stage 510(N) receives a start signal RVST and clock signals RCLK(N-1), RCLK(N), and RCLK(N+2) and outputs a pulse of a first rendering signal RS1. The pulse of the first rendering signal RS1 is input to the N-th controller 530(N) of the output controller CS and is simultaneously input as a carry signal to the (N+1)-th signal transfer stage 510(N+1). The (N+1)-th signal transfer stage 510(N+1) receives the carry signal RS1 from the N-th signal transfer stage 510(N) and clock signals RCLK(N), RCLK(N+1), and RCLK(N+3) and outputs a pulse of a second rendering signal RS2. The pulse of the second rendering signal RS2 is input to the (N+1)-th controller 530(N+1) of the output controller CS and is simultaneously input as a carry signal to the (N+2)-th signal transfer stage 510(N+2), which is not shown in FIG. 7 for brevity. The N-th signal transfer stage 510(N) and the (N+1)-th signal transfer stage 510(N+1) may be understood as a first signal transfer stage and a second signal transfer stage, respectively.

Hereinafter, a circuit configuration of the signal transfer stages 510(N) and 510(N+1) will be described mainly with reference to the N-th signal transfer stage 510(N).

A first transistor T01 is connected between a VST node 71 and a Q02 node and may be turned on in response to a clock signal RCLK(N−1) input to a first clock node 72 to electrically connect the VST node 71 to the Q02 node. The first transistor T01 includes a gate electrode connected to the first clock node 72, a first electrode connected to the VST node 71, and a second electrode connected to the Q02 node. A second transistor T02 may be turned on in response to a voltage of a QB01 node to electrically connect a VGH node 76 to which a gate high voltage is applied to the Q02 node. The second transistor T02 includes a gate electrode connected to the QB01 node, a first electrode connected to the Q02 node, and a second electrode connected to the VGH node 76.

A third transistor T03 is connected between a VGL node 74 to which a gate low voltage is applied and a QB01 node and may be turned on in response to a clock signal RCLK(N+2) input to a second clock node 73 to electrically connect the VGL node 74 to the QB01 node. The third transistor T03 includes a gate electrode connected to the second clock node 73, a first electrode connected to the VGL node 74, and a second electrode connected to the QB01 node. A fourth transistor T04 is connected between the QB01 node and the VGH node 76 and may be turned on in response to a voltage of the VST node 71 to electrically connect the QB01 node to the VGH node 76. The fourth transistor T04 includes a gate electrode connected to the VST node 71, a first electrode connected to the QB01 node, and a second electrode connected to the VGH node 76. A fifth transistor T05 is connected between the QB01 node and the VGH node 76 and may be turned on in response to a voltage of the Q02 node to electrically connect the QB01 node to the VGH node 76. The fifth transistor T05 includes a gate electrode connected to the Q02 node, a first electrode connected to the QB01 node, and a second electrode connected to the VGH node 76.

A sixth transistor T06 is connected between a third clock node 75 and an output node 77 and may be turned on in response to a voltage of a Q01 node to electrically connect the third clock node 75 to the output node 77. The sixth transistor T06 may be understood as a pull-up transistor. The sixth transistor T06 includes a gate electrode connected to the Q01 node, a first electrode connected to the third clock node 75, and a second electrode connected to the output node 77. A capacitor CQ1 is connected between the Q01 node and the output node 77. The capacitor CQ1 boosts a voltage of the Q01 node by bootstrapping through capacitor coupling between the output node 77 and the Q01 node when a voltage of the third clock node 75 rises.

A seventh transistor T07 is connected between the output node 77 and the VGH node 76 and is turned on in response to a voltage of the QB01 node. The seventh transistor T07 may be understood as a pull-down transistor. The seventh transistor T07 includes a gate electrode connected to the QB01 node, a first electrode connected to the output node 77, and a second electrode connected to the VGH node 76. A capacitor CQB1 is connected between the QB01 node and the VGH node 76 to reduce a gate-source voltage variation of the seventh transistor T07.

An eighth transistor T08 is connected between the Q01 node and the Q02 node and electrically separates the Q01 node and the Q02 node when the Q01 node is bootstrapped to reduce stress on the first transistor T01. The eighth transistor T08 includes a gate electrode connected to the VGL node 74, a first electrode connected to the Q02 node, and a second electrode connected to the Q01 node.

Each of the signal transfer stages 520(N) and 520(N+1) of the gate signal output circuit OSS includes a first-first control node (hereinafter referred to as “T6Q node”), a first-second control node (hereinafter referred to as “Q2 node”), a second control node (hereinafter referred to as “QB node”), and a plurality of transistors T1 to T7. Each of the transistors T1 to T7 may be implemented as a p-channel LTPS TFT, but is not limited thereto.

The signal transfer stages 520(N) and 520(N+1) may be implemented with substantially the same circuit. The N-th signal transfer stage 520(N) receives a start signal GVST and a clock signal GCLK1 and outputs a pulse of a first gate signal to a first output node 85. The first output node 85 is shared by the N-th signal transfer stage 520(N) and the N-th controller 530(N). The pulse of the first gate signal is input to the N-th controller 530(N) and is simultaneously input as a carry signal CAR to the (N+1)-th signal transfer stage 520(N+1). The (N+1)-th signal transfer stage 520(N+1) receives the carry signal CAR from the N-th signal transfer stage 520(N) and a clock signal GCLK2 and outputs a pulse of a first gate signal to a first output node. The first output node of the (N+1)-th signal transfer stage 520(N+1) is shared by the (N+1)-th controller 530(N+1). The pulse of the second gate signal is input to the (N+1)-th controller 530(N+1) and is simultaneously input as a carry signal CAR to the (N+2)-th signal transfer stage 520(N+2), which is not shown in FIG. 7 for brevity. The N-th signal transfer stage 520(N) and the (N+1)-th signal transfer stage 520(N+1) may be understood as a first signal transfer stage and a second signal transfer stage, respectively.

Hereinafter, a circuit configuration of the signal transfer stages 520(N) and 520(N+1) will be described mainly with reference to the N-th signal transfer stage 520(N).

A first transistor T1 is connected between a VST node 81 and a Q2 node and may be turned on in response to a clock signal GCLK1 input to a clock node 88 connected to a clock wire 1211 to electrically connect the VST node 81 to the Q2 node. The first transistor T1 includes a gate electrode connected to the clock node 88, a first electrode connected to the VST node 81, and a second electrode connected to the Q2 node. A second transistor T2 may be turned on in response to the a start signal GVST to electrically connect a buffer node 87 to a VEH node 82 to which a gate high voltage is applied. The second transistor T2 includes a gate electrode connected to the VST node 81, a first electrode connected to the buffer node 87, and a second electrode connected to the VEH node 82. A capacitor CON is connected between the buffer node 87 and the clock node 88.

A third transistor T3 is connected between the clock node 88 and a QB node and may be turned on in response to a voltage of the buffer node 87 to electrically connect the clock node 88 to the QB node. The third transistor T3 includes a gate electrode connected to the buffer node 87, a first electrode connected to the clock node 88, and a second electrode connected to the QB node. The third transistor T3 may be composed of two transistors connected in series between the clock node 88 and the QB node, but is not limited thereto.

A fourth transistor T4 is connected between the QB node and a VEH node 82 to which a gate high voltage is applied and may be turned on in response to a voltage of the Q2 node to electrically connect the QB node to the VEH node 82. The fourth transistor T4 includes a gate electrode connected to the Q2 node, a first electrode connected to the QB node, and a second electrode connected to the VEH node 82. A fifth transistor T5 is connected between a T6Q node and the Q2 node and is turned on when a voltage of the Q2 node rises, and electrically separates the T6Q node and the Q2 node when the T6Q node is bootstrapped. The fifth transistor T5 includes a gate electrode connected to a VEL node 84 to which a gate low voltage is applied, a first electrode connected to the Q2 node, and a second electrode connected to the T6Q node.

A sixth-first transistor T6C is connected between the VEL node 84 and a first output node 85 and may be turned on in response to a voltage of the T6Q node to electrically connect the VEL node 84 to the first output node 85. The sixth-first transistor T6C may be understood as a first pull-up transistor. The sixth-first transistor T6C includes a gate electrode connected to the T6Q node, a first electrode connected to the VEL node 84, and a second electrode connected to the first output node 85. A capacitor CQ2 is connected between the T6Q node and the first output node 85.

A seventh transistor T7 is connected between the first output node 85 and the VEH node 82 and is turned on in response to a voltage of the QB node. The seventh transistor T7 may be understood as a pull-down transistor. The seventh transistor T7 includes a gate electrode connected to the QB node, a first electrode connected to the first output node 85, and a second electrode connected to the VEH node 82. A capacitor CQB2 is connected between the QB node and the VEH node 82.

Each of the controllers 530(N) and 530(N+1) of the output controller CS includes a sixth-second transistor T6O, an eighth transistor T8, a ninth transistor T9, and a capacitor Cf. Each of the transistors T6O, T8, and T9 may be implemented as a p-channel LTPS TFT, but is not limited thereto. Each of the sixth-second transistor T6O , the eighth transistor T8, and the ninth transistor T9 may be understood as a control transistor.

The controllers 530(N) and 530(N+1) may be implemented with substantially the same circuit. The N-th controller 530(N) samples a voltage of a frequency control signal FD in response to a pulse of the first rendering signal RS1 and stores it in the capacitor Cf. The (N+1)-th controller 530(N+1) samples a voltage of the frequency control signal FD in response to a pulse of the second rendering signal RS2 generated following the pulse of the first rendering signal RS1 and stores it in the capacitor Cf. A capacitance of the capacitor Cf may be equal to or similar to a capacitance of the capacitor Cst disposed in the pixel circuit.

The controllers 530(N) and 530(N+1) are connected to the signal transfer stages 520(N) and 520(N+1) in a one-to-one (1:1) manner. The N-th controller 530(N) is connected to the N-th signal transfer stage 520(N), receives an N-th gate signal from the N-th signal transfer stage 520(N), and shares a T6Q node with the N-th signal transfer stage 520(N). The (N+1)-th controller 530(N+1) is connected to the (N+1)-th signal transfer stage 520(N+1), receives an (N+1)-th gate signal from the (N+1)-th signal transfer stage 520(N+1), and shares a T6Q node with the (N+1)-th signal transfer stage 520(N+1).

Each of the controllers 530(N) and 530(N+1) may output a pulse of the gate signal input from the signal transfer stages 520(N) and 520(N+1) as a final gate signal SRO1, SRO2 to a second output node 86 according to a first voltage of the frequency control signal FD charged in the capacitor Cf. Each of the controllers 530(N) and 530(N+1) blocks the pulse of the gate signal input from the signal transfer stages 520(N) and 520(N+1) according to a second voltage of the frequency control signal FD charged in the capacitor Cf, and supplies a gate low voltage VEL to the second output node 86 or maintains a voltage of the second output node 86 at the gate low voltage VEL. The second output node 86 may be connected to the first gate line GL1 or the fourth gate line GL4 shown in FIG. 3. The first voltage of the frequency control signal FD may be a gate low voltage, and the second voltage of the frequency control signal FD may be a gate high voltage, but is not limited thereto. The N-th controller 530(N) and the (N+1)-th controller 530(N+1) may be understood as a first controller and a second controller, respectively.

A sixth-second transistor T6O is connected between the VEL node 84 and a second output node 86 and may be turned on in response to a voltage of the T6Q node to electrically connect the VEL node 84 to the second output node 86. The sixth-second transistor T6O may be understood as a second pull-up transistor. The sixth-second transistor T6O includes a gate electrode connected to the T6Q node, a first electrode connected to the VEL node 84, and a second electrode connected to the second output node 86.

An eighth transistor T8 is connected between a node 83 connected to the capacitor Cf and a wire 1212 to which a frequency control signal FD is applied, and is turned on in response to the rendering signal RS1 (for the controller 530(N)) or RS2 (for the controller 530(N+1)). The eighth transistor T8 includes a gate electrode connected to an output node 77 of the rendering signal generator RSS to which the rendering signal RS1 (for the controller 530(N)) or RS2 (for the controller 530(N+1)) is applied, a first electrode connected to the capacitor Cf, and a second electrode to which the frequency control signal FD is applied. One electrode of the capacitor Cf is connected to the node 83, and the other electrode is connected to a ground voltage source or a separate reference voltage source.

A ninth transistor T9 is connected between the first output node 85 and the second output node 86 and is turned on in response to a voltage of the capacitor Cf. The ninth transistor T9 includes a gate electrode connected to the capacitor Cf, a first electrode connected to the first output node 85, and a second electrode connected to the second output node 86.

It is noted that clock signals RCLK(N−1), RCLK(N), and RCLK(N+2) of FIG. 7 may correspond to the clock signals that are input into clock nodes CLK(N−1), CLK(N), and CLK(N+2) of FIG. 6, respectively. First and second rendering signals RS1 and RS2 of FIG. 7 may correspond to rendering signals RS(N) and RS(N+1) of FIG. 6, respectively. A clock node 88 of the signal transfer stage 520(N) of FIG. 7 may correspond to the clock node CLK(N) of the signal transfer stage 520(N) of FIG. 6.

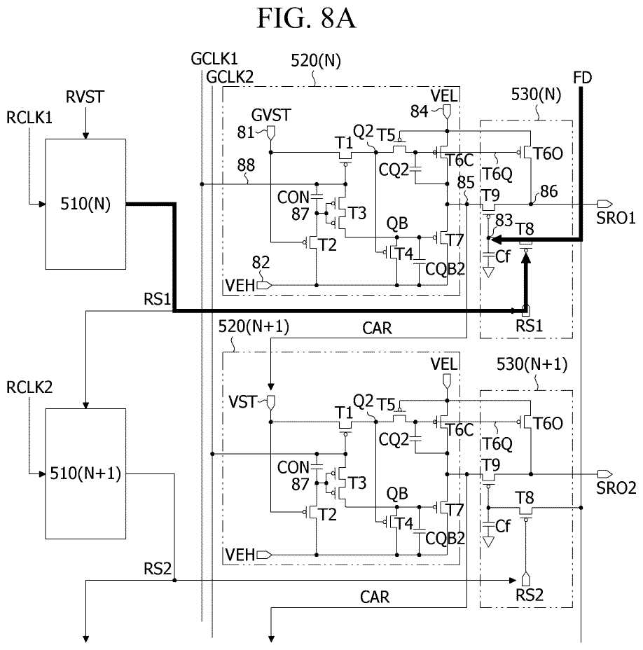

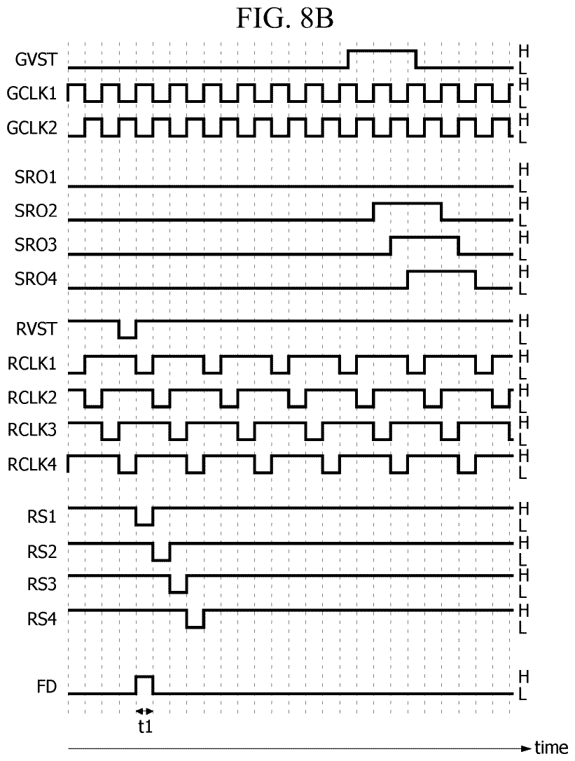

FIGS. 8A to 13B are examples of views illustrating an operation of the output controller shown in FIG. 7. In FIGS. 8B, 9B, 10B, and 11B, GVST, GCLK1, and GCLK2 are a start signal and clock signals input to the signal transfer stages 520(N) and 520(N+1) of the gate signal output circuit OSS. SRO1 to SRO 4 are final gate signals output under the control of the controllers 530(N) and 530(N+1). The final gate signal may correspond to the first gate signal SC1 or the fourth gate signal SC4 in FIG. 3. RVST and RCLK1 to RCLK4 are a start signal and clock signals input to the signal transfer stages 510(N) and 510(N+1) of the rendering signal generator RSS. RS1 to RS4 are rendering signals sequentially output from the signal transfer stages 510(N) and 510(N+1) of the rendering signal generator RSS. In FIGS. 8B, 9B, 10B, and 11B, “L” is a gate low voltage, and “H” is a gate high voltage. The gate low voltage L is substantially the same voltage as the gate low voltage VGL, VEL shown in FIG. 7. The gate high voltage H is substantially the same voltage as the gate high voltage VGH, VEH shown in FIG. 7.

The embodiment shown in FIGS. 8A to 11B is an example in which the N-th controller 530(N) controls a voltage of the gate signals SC1 and SC4 applied to pixels of a skip pixel line, while the (N+1)-th controller 530(N+1) controls a voltage of the gate signals SC1 and SC4 applied to pixels of a refresh pixel line. According to the frequency control signal FD, the N-th controller 530(N) may control pixels of a refresh pixel line, and the (N+1)-th controller 530(N+1) may control pixels of a skip pixel line. The refresh pixel line includes pixels in which data is updated by charging a data voltage Vdata of pixel data. The skip pixel line includes pixels in which data is not updated by maintaining the first and fourth gate signals SC1 and SC4 at a gate off voltage, that is, a gate low voltage L.

Referring to FIGS. 8A and 8B, at a time point t1, a gate low voltage L of the first rendering signal RS1 is applied to a gate electrode of the eighth transistor T8, and at the same time, a gate high voltage H of the frequency control signal FD is applied to the eighth transistor T8. As a result, when the eighth transistor T8 of the N-th controller 530(N) is turned on at the time point t1, the gate high voltage H of the frequency control signal FD is charged in the capacitor Cf. At the time point t1, since the rendering signals equal to or lower than the second rendering signal RS2 are not generated, the (N+1)-th controller 530(N+1) to which the second rendering signal RS2 is applied maintains a previous state.

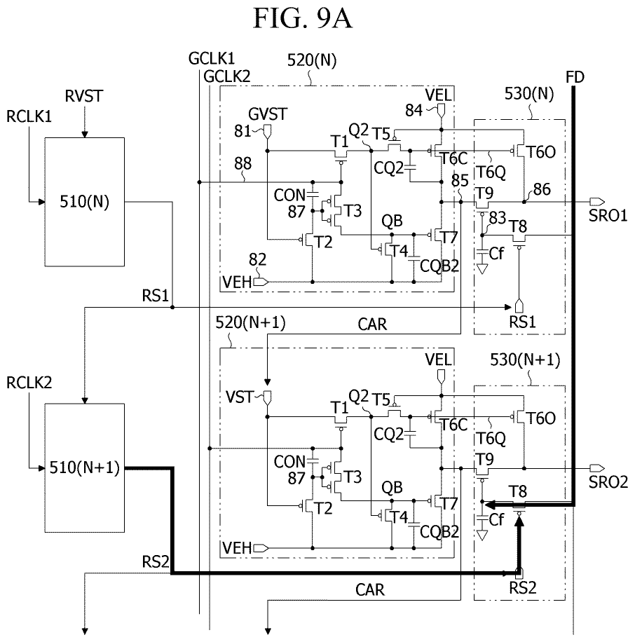

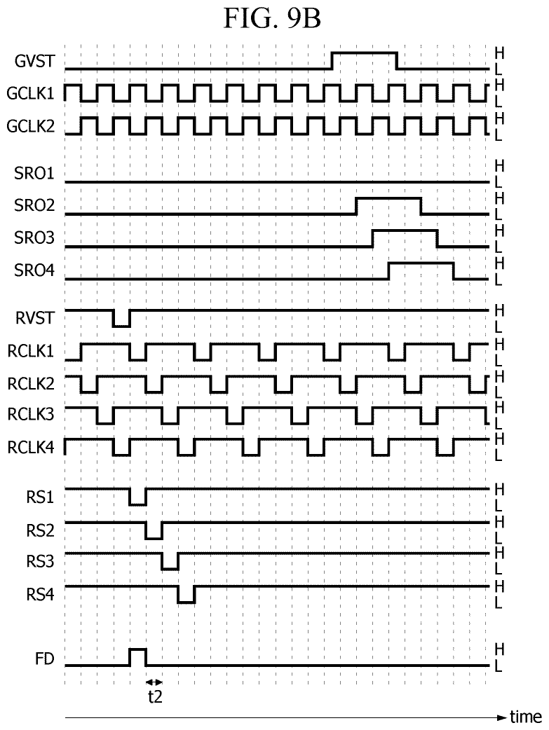

Referring to FIGS. 9A and 9B, at a time point t2, a gate low voltage L of the second rendering signal RS2 is applied to a gate electrode of the eighth transistor T8, and at the same time, a gate low voltage L of the frequency control signal FD is applied to the eighth transistor T8. As a result, when the eighth transistor T8 of the (N+1)-th controller 530(N+1) is turned on at the time point t2, the gate low voltage H of the frequency control signal FD is charged in the capacitor Cf. At the time point t2, since the first rendering signal RS1 is at the gate high voltage H, a capacitor voltage of the N-th controller 530(N) is maintained at the gate high voltage H.

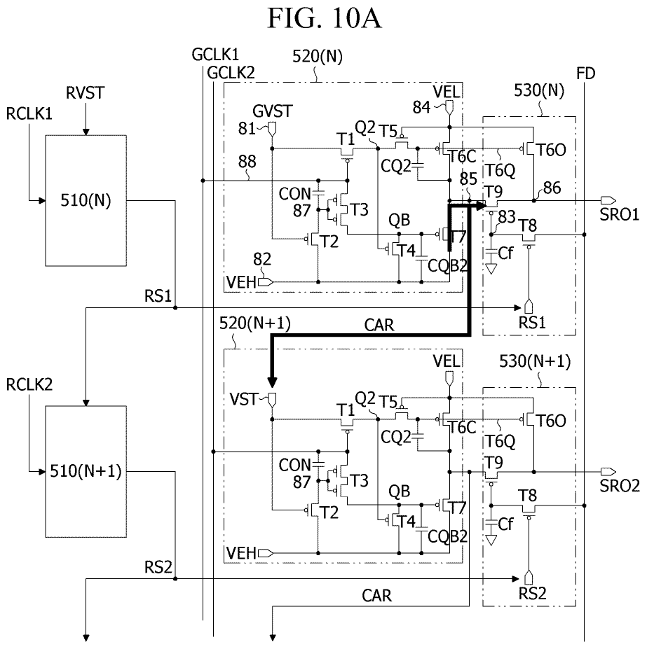

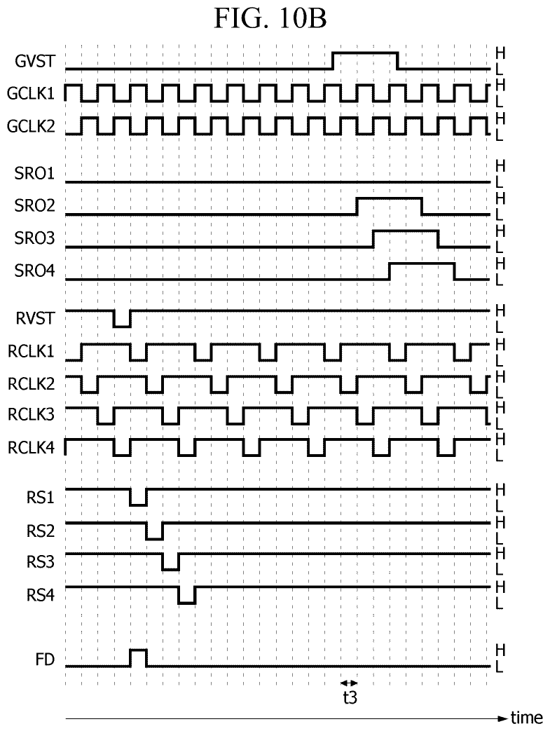

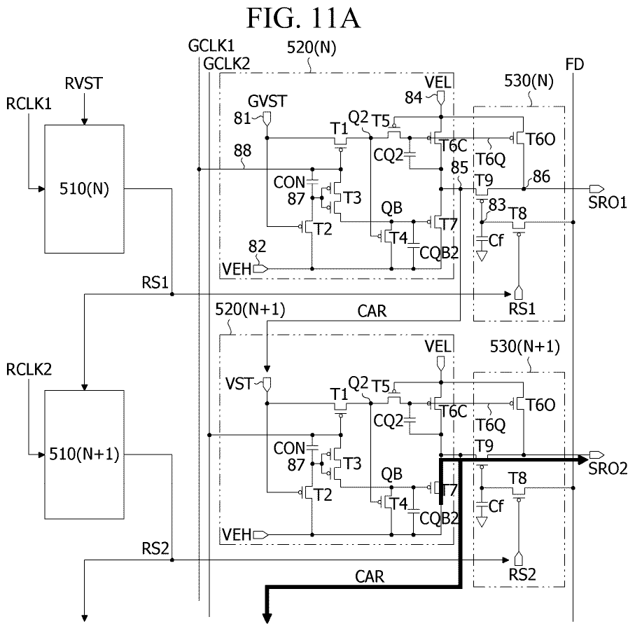

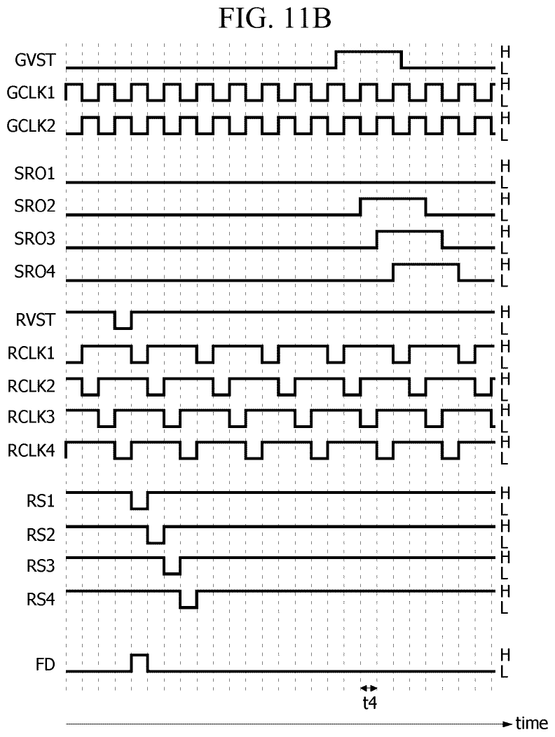

Referring to FIGS. 10A to 11B, at time points t3 and t4, the rendering signals RS1 to RS4 are maintained at the gate high voltage, and the eighth transistors T8 of the controllers 530(N) and 530(N+1) are in an off state. At the time point t3, a voltage charged in the capacitor Cf of the N-th controller 530(N) is the gate high voltage H. At the time point t4, a voltage charged in the capacitor Cf of the (N+1)-th controller 530(N+1) is the gate low voltage L.

At the time point t3, a pulse of the gate signal output from the N-th signal transfer stage 520(N) is blocked by the ninth transistor T9 turned off by the gate high voltage H charged in the capacitor Cf of the N-th controller 530(N) as shown in FIG. 10A. Here, the gate signal SRO1 output from the N-th controller 530(N) is maintained at the gate low voltage L and is applied to pixels of the skip pixel line.

At the time point t4, a pulse of the gate signal output from the (N+1)-th signal transfer stage 520(N+1) is output as a gate signal SRO2 through the ninth transistor T9 turned on by the gate low voltage L charged in the capacitor Cf of the (N+1)-th controller 530(N+1) as shown in FIG. 11A. Here, the pulse of the gate signal SRO2 output from the (N+1)-th controller 530(N+1) is applied to pixels of the refresh pixel line.

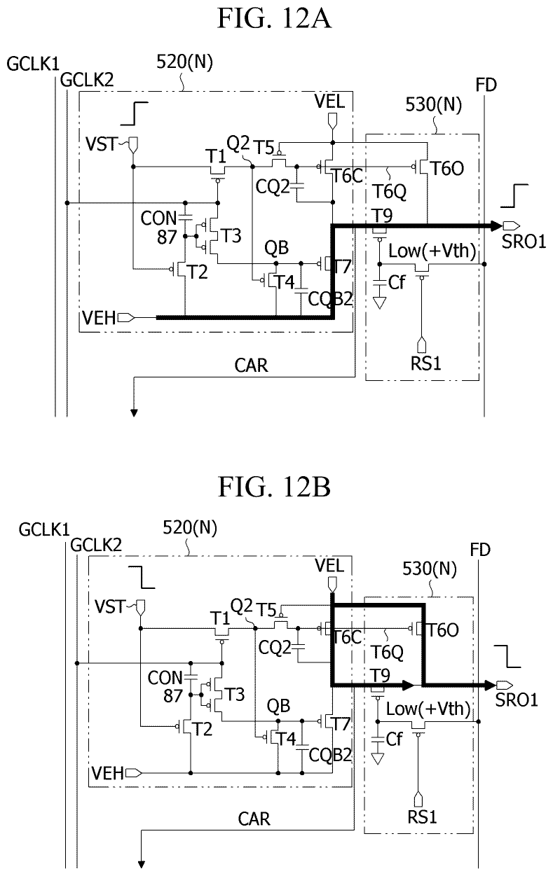

FIGS. 12A and 12B are circuit diagrams of a portion of the gate driver shown in FIG. 7 that is used to apply gate signals to pixels of a refresh pixel line.

Referring to FIG. 12A, when a VST node voltage of the signal transfer stage 520(N) changes from a gate low voltage to a gate high voltage, a voltage of the T6Q node rises, and the sixth-first transistor T6C and the sixth-second transistor T6O are turned off. Here, a voltage of the gate signal SRO1 may be increased from the gate low voltage L to the gate high voltage H by the gate high voltage VEH output through the seventh and ninth transistors T7 and T9.

Referring to FIG. 12B, when the VST node voltage of the signal transfer stage 520(N) changes from the gate high voltage to the gate low voltage, a voltage of T6Q falls, and the sixth-first transistor T6C and the sixth-second transistor T6O are turned on. Here, a voltage of the gate signal SRO1 is lowered from the gate high voltage H to the gate low voltage L by the gate low voltage VEL output through the sixth-first transistor T6C and the sixth-second transistor T6O.

In a structure in which the sixth-first transistor T6C and the sixth-second transistor T6O share the T6Q node, if the sixth-second transistor T6O is absent, a low voltage L of the gate signal SRO may rise by VEL+a. Here, a is a threshold voltage of each of the eighth and ninth transistors T8 and T9. In this case, a leakage current may be generated in a transistor of the pixel circuit controlled by the gate signal SRO, for example, the first transistor M01 or the fifth transistor M05 shown in FIG. 3, or the pixel circuit may not be driven normally because it is not turned off.

When a voltage of the T6Q node changes from the gate high voltage to the gate low voltage, it is boosted to a voltage lower than VEL by bootstrapping through the capacitor CQ2.The sixth-second transistor T6O is quickly turned on with a low on-resistance by the gate low voltage of the T6Q node, and may prevent a rise of the gate low voltage L when a pulse of the gate signal SRO1 is lowered from the gate high voltage H to the gate low voltage L.

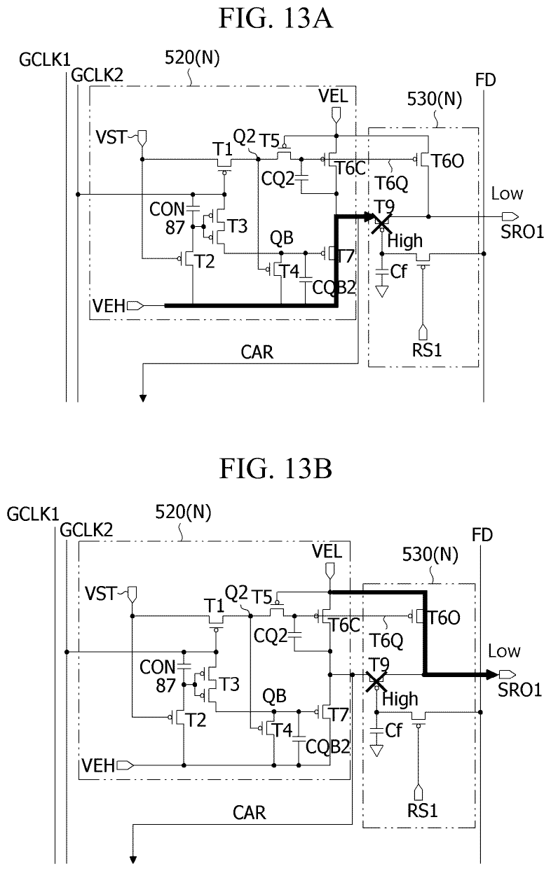

FIGS. 13A and 13B are circuit diagrams of a portion of the gate driver shown in FIG. 7 that is used to apply gate signals to pixels of a skip pixel line.

Referring to FIGS. 13A and 13B, when a voltage charged in the capacitor Cf of the controller 530(N) is a gate high voltage, the ninth transistor T9 is in an off state. Here, a pulse of the gate signal applied to the first output node 85 is blocked by the ninth transistor T9 in the off state, and the gate low voltage VEL is applied to the second output node 86 through the sixth-second transistor T6O turned on, and a voltage of the gate signal SRO may be maintained at the gate low voltage VEL.

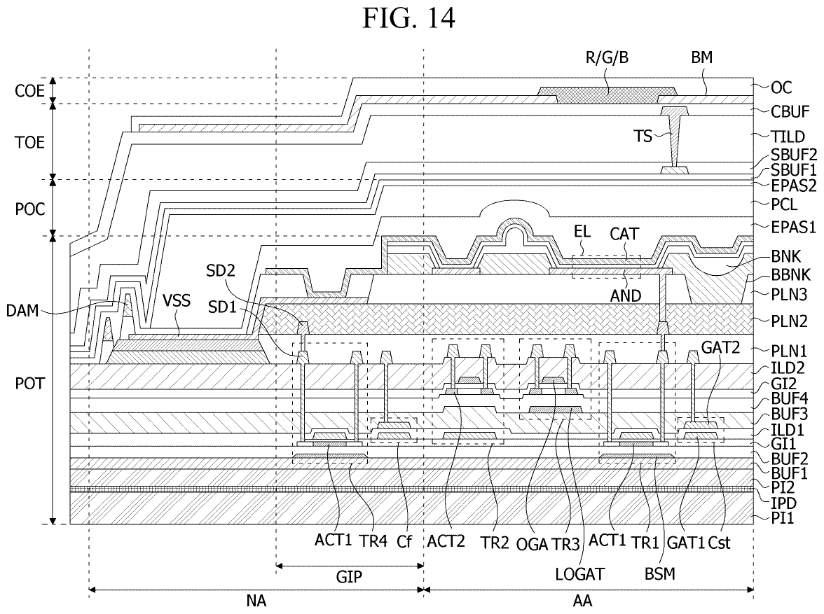

FIG. 14 is a cross-sectional view showing a cross-sectional structure of a display panel according to an example embodiment of the present disclosure.

Referring to FIG. 14, a cross-sectional structure of the display panel 100 may include a circuit layer POT, an encapsulation layer POC, a touch sensor layer TOE, a color filter layer COE, and the like.

The circuit layer POT may have a structure in which a light-emitting element is disposed on a circuit of a pixel circuit and a gate driver disposed on a substrate. A substrate of the display panel 100 may be manufactured in a structure in which a first polyimide (hereinafter, referred to as “PI”) substrate PI1, an inorganic layer IPD, and a second PI substrate PI2 are stacked, but is not limited thereto. The inorganic layer IPD blocks moisture penetration.

The circuit layer POT may be divided into a pixel circuit layer and a light-emitting element layer. The pixel circuit layer includes a first insulating layer BUF1, a first metal layer BSM disposed on the first insulating layer BUF1, a second insulating layer BUF2 covering the first metal layer BSM and the first insulating layer BUF1, a first semiconductor layer ACT1 disposed on the second insulating layer BUF2, a third insulating layer GI1 covering the first semiconductor layer ACT1 and the second insulating layer BUF2, a second metal layer GAT1 disposed on the third insulating layer GI1, a fourth insulating layer ILD1 covering the second metal layer GAT1 and the third insulating layer GI1, a third metal layer GAT2 disposed on the fourth insulating layer ILD1, a fifth insulating layer BUF3 covering the third metal layer GAT2 and the fourth insulating layer ILD1, a fourth metal layer LOGAT disposed on the fifth insulating layer BUF3, a sixth insulating layer BUF4 covering the fourth metal layer LOGAT and the fifth insulating layer BUF3, a second semiconductor layer ACT2 disposed on the sixth insulating layer BUF4, a seventh insulating layer GI2 covering the second semiconductor layer ACT2 and the sixth insulating layer BUF4, a fifth metal layer OGA disposed on the seventh insulating layer GI2, an eighth insulating layer ILD2 covering the fifth metal layer OGA and the seventh insulating layer GI2, a sixth metal layer SD1 disposed on the eighth insulating layer ILD2, a ninth insulating layer PLN1 covering the sixth metal layer SD1 and the eighth insulating layer ILD2, a seventh metal layer SD2 disposed on the ninth insulating layer PLN1, a tenth insulating layer PLN2 covering the seventh metal layer SD2 and the ninth insulating layer PLN1, an eleventh insulating layer PLN3 covering the tenth insulating layer PLN2, and the like. The first to eighth insulating layers BUF1 to ILD2 may be inorganic layers. The ninth to eleventh insulating layers PLN1, PLN2, and PL3 may be organic layers.

Metal layers of the circuit layer POT may be used as electrodes of transistors and wires connected to the transistors. A first transistor TR1, a second transistor TR2, a third transistor TR3, and a capacitor Cst may be elements of a pixel circuit disposed in the display area AA. A fourth transistor TR4 and a capacitor Cf may be elements disposed in a gate driving circuit area GIP in the non-display area NA. Although omitted in FIG. 14, a transistor having substantially the same structure as the second transistor TR2 and/or the third transistor TR3 may be disposed in the gate driving circuit area GIP. The first semiconductor layer ACT1 may include a polysilicon semiconductor layer. The second semiconductor layer may include an oxide semiconductor layer. The first transistor TR1 may be a transistor implemented as an LTPS TFT among transistors of the pixel circuit. The second and third transistors TR2 and TR3 may be transistors implemented as Oxide TFTs among transistors of the pixel circuit. A metal pattern formed of a selected metal layer may be disposed under the semiconductor layers ACT1 and ACT2 of the transistors. A thickness of the insulating layer between the semiconductor layers ACT1 and ACT2 and the metal pattern may be appropriately selected.

The light-emitting element layer includes an anode electrode AND connected to the first transistor TR1 via a contact hole penetrating the insulating layers PLN2 and PLN3, a cathode electrode CAT connected to a power line VSS to which a cathode voltage ELVSS is applied, an emission layer disposed between the anode electrode AND and the cathode electrode CAT, a black bank BBNK that partitions sub-pixels, a transparent bank BNK, and the like. The anode electrode AND may be disposed in an emission area separated below the banks BBNK and BNK and defined by the banks BBNK and BNK. A surface of the black bank BBNK may be recessed and a trench may be formed at the boundary of adjacent sub-pixels. The trench may extend a current path in a side direction between adjacent sub-pixels in the light-emitting element layer, thereby reducing a leakage current flowing in the side direction.

The encapsulation layer POC covers the circuit layer POT. The encapsulation layer POC may be a multi-insulating film structure in which an organic film PCL and inorganic films EPAS1 and EPAS2 are stacked. The inorganic films EPAS1 and EPAS2 block moisture permeation. The organic film PCL planarizes the surface of the encapsulation layer POC. A dam DAM may be disposed in the outermost portion of the display panel 100. The dam DAM has a thick structure in which organic films PLN1 and PLN2 are stacked. The dam DAM can extend a moisture permeation path and suppress a phenomenon that an organic film flows to the outermost portion of the display panel when the organic film of the encapsulation layer POC is applied.

The touch sensor layer TOE covers the encapsulation layer POC. The touch sensor layer TOE includes a touch sensor TS disposed on the display area AA. The touch sensor TS may be a static capacitance type touch sensor that senses a touch input on the basis of change in capacitance before and after the touch input. The touch sensor layer TOE may include metal layers that are used as electrodes of touch sensors, an organic film TILD, and inorganic insulating films SBUF1, SBUF2, and CBUF.

The color filter layer COE covers the touch sensor layer TOE. The color filter layer COE includes a color filter R/G/B, a black matrix BM, and an organic film OC that covers the color filter R/G/B and the black matrix BM. The color filter layer COE can improve the color reproducibility of the pixels, and can reduce the transmittance of light reflected by metals of the touch sensor layer TOE and the circuit layer POT, thereby improving visibility and a contrast ratio. The organic film OC protects the color filter R/G/B and the black matrix BM and planarizes the surface of the color filter layer COE. The black matrix BM may be disposed at the boundary of adjacent sub-pixels, thereby reducing optical crosstalk between adjacent sub-pixels. The black matrix BM may be disposed in the gate driving circuit area GIP of the non-display area NA and cover the underlying circuit elements.

In one or more examples, unless expressly stated otherwise, an element may refer to a device or a circuit. In an example, a light-emitting element may refer to a light-emitting device. In an example, a driving element may refer to a driving circuit. In an example, a switch element may refer to a switch circuit.

According to one or more embodiments of the present disclosure, the display device may be included in or applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display device according to one or more embodiments of the present disclosure may be included in or applied to organic light emitting lighting devices or inorganic light emitting lighting devices.

The objects to be achieved by the present disclosure, the means for achieving the objects, and effects of the present disclosure described above do not specify essential features of the claims, and thus, the scope of the claims is not limited to the disclosure of the present disclosure.

Although one or more example embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and do not limit the technical concept of the present disclosure. The scope of the technical concept of the present disclosure is not limited thereto. Therefore, it should be understood that the above-described embodiments are illustrative in all aspects and do not limit the present disclosure. Thus, the present disclosure covers the modifications and variations of this disclosure provided they come within the scope of the claims or their equivalents.

What is claimed is:

1. A display panel, comprising:
a display area in which a plurality of data lines, a plurality of gate lines, a plurality of power lines, and a plurality of sub-pixels are disposed; and
a gate driver connected to the plurality of gate lines,
wherein the gate driver comprises:
a rendering signal generator configured to sequentially output a rendering signal;
a gate signal output circuit configured to sequentially output a gate signal; and
an output controller configured to receive the rendering signal, the gate signal, and a frequency control signal to output a pulse of the gate signal to a corresponding gate line or to maintain a voltage of the corresponding gate line at a first gate voltage.

2. The display panel according to claim 1, wherein the gate signal output circuit comprises:
a plurality of signal transfer stages connected to one or more clock wires to which one or more clock signals are applied, the plurality of signal transfer stages sequentially connected through a carry signal wire that propagates a carry signal from a preceding stage to a succeeding stage among the plurality of signal transfer stages, each of the plurality of signal transfer stages configured to output a corresponding gate signal to a corresponding first output node,
wherein the output controller comprises:
a plurality of controllers, each connected to a corresponding one of the plurality of signal transfer stages of the gate signal output circuit, each of the plurality of controllers configured to receive the corresponding gate signal from a corresponding signal transfer stage, receive the frequency control signal, and output a corresponding final gate signal to a corresponding second output node connected to a respective gate line, and
wherein the corresponding final gate signal includes a pulse of the corresponding gate signal or a signal maintained at the first gate voltage.

3. The display panel according to claim 1, wherein the gate signal output circuit comprises:
a first signal transfer stage configured to output a pulse of a first gate signal; and
a second signal transfer stage configured to receive the pulse of the first gate signal as a carry signal and output a pulse of a second gate signal following the pulse of the first gate signal, and wherein the output controller comprises:
a first controller configured to receive the pulse of the first gate signal, a pulse of a first rendering signal, and the frequency control signal; and
a second controller configured to receive the pulse of the second gate signal, a pulse of a second rendering signal generated following the pulse of the first rendering signal, and the frequency control signal.

4. The display panel according to claim 1, wherein:
the gate signal output circuit comprises a plurality of signal transfer stages;
the output controller comprises a plurality of controllers;
an N-th signal transfer stage among the plurality of signal transfer stages is configured to output an N-th gate signal to a first output node in response to a voltage of a Q node;
an N-th controller among the plurality of controllers is configured to share the Q node and output an N-th final gate signal to a second output node in response to an N-th rendering signal, the N-th gate signal, and the frequency control signal; and
N is a natural number.

5. The display panel according to claim 4, wherein the N-th controller comprises:
a first control transistor including a gate electrode connected to the Q node, a first electrode connected to a VEL node to which the first gate voltage is applied, and a second electrode connected to the second output node;
a capacitor in which a voltage of the frequency control signal is charged;
a second control transistor including a gate electrode to which the N-th rendering signal is applied, a first electrode connected to the capacitor, and a second electrode to which the frequency control signal is applied; and
a third control transistor including a gate electrode connected to the capacitor, a first electrode connected to the first output node, and a second electrode connected to the second output node.

6. The display panel according to claim 1, wherein the gate signal output circuit comprises a plurality of signal transfer stages,
wherein an N-th signal transfer stage among the plurality of signal transfer stages comprises:
a first transistor including a gate electrode connected to a clock node to which a clock signal is applied, a first electrode connected to a VST node to which a start signal or a carry signal is input, and a second electrode connected to a Q2 node;
a second transistor including a gate electrode connected to the VST node, a first electrode connected to a buffer node, and a second electrode connected to a VEH node to which a second gate voltage is applied;
a first capacitor between the buffer node and the clock node;
a third transistor including a gate electrode connected to the buffer node, a first electrode connected to the clock node, and a second electrode connected to a QB node;
a fourth transistor including a gate electrode connected to the Q2 node, a first electrode connected to the QB node, and a second electrode connected to the VEH node;
a fifth transistor including a gate electrode connected to a VEL node to which the first gate voltage is applied, a first electrode connected to the Q2 node, and a second electrode connected to a Q node;
a sixth-first transistor including a gate electrode connected to the Q node, a first electrode connected to the VEL node, and a second electrode connected to a first output node;
a second capacitor connected between the Q node and the first output node;
a seventh transistor including a gate electrode connected to the QB node, a first electrode connected to the first output node, and a second electrode connected to the VEH node; and
a third capacitor connected between the QB node and the VEH node, and
wherein the N-th signal transfer stage is configured to output an N-th gate signal to the first output node.

7. The display panel according to claim 6, wherein the output controller comprises a plurality of controllers,
wherein an N-th controller among the plurality of controllers comprises:
a sixth-second transistor including a gate electrode connected to the Q node, a first electrode connected to the VEL node, and a second electrode connected to a second output node;
a fourth capacitor in which a voltage of the frequency control signal is charged;
an eighth transistor including a gate electrode to which an N-th rendering signal is applied, a first electrode connected to the fourth capacitor, and a second electrode to which the frequency control signal is applied; and
a ninth transistor including a gate electrode connected to the fourth capacitor, a first electrode connected to the first output node, and a second electrode connected to the second output node, and
wherein the N-th controller is configured to output an N-th final gate signal to the second output node.

8. The display panel according to claim 1, wherein each of the plurality of sub-pixels comprises:
a light-emitting device;
a driving circuit configured to drive the light-emitting device;
a capacitor connected to the driving circuit; and
one or more switch circuits connected to the capacitor.

9. The display panel according to claim 8, wherein:
each of the one or more switch circuits includes a transistor;
the first gate voltage or the pulse of the gate signal output from the output controller is applied to the corresponding gate line; and
the corresponding gate line is connected to a gate electrode of the transistor.

10. The display panel according to claim 1, wherein each of the plurality of sub-pixels comprises:
a driving transistor including a gate electrode connected to a first node, a first electrode connected to a second node, and a second electrode connected to a third node;
a light-emitting device including an anode electrode connected to a fourth node and a cathode electrode to which a cathode voltage is applied;
a capacitor connected between a node to which a pixel driving voltage is applied and the first node;
a first switch transistor including a gate electrode to which a first gate signal is applied, a first electrode connected to the first node, and a second electrode connected to the third node;
a second switch transistor including a gate electrode to which a second gate signal is applied, a first electrode connected to a data line, and a second electrode connected to the second node;
a third switch transistor including a gate electrode to which a fifth gate signal is applied, a first electrode connected to the node to which the pixel driving voltage is applied, and a second electrode connected to the second node;
a fourth switch transistor including a gate electrode to which the fifth gate signal is applied, a first electrode connected to the third node, and a second electrode connected to the fourth node;
and a fifth switch transistor including a gate electrode to which a fourth gate signal is applied, a first electrode connected to the first node, and a second electrode to which an initialization voltage is applied, and
wherein the pulse of the gate signal output from the output controller or the first gate voltage is at least one of the first gate signal and the fourth gate signal.

11. The display panel according to claim 10, wherein each of the plurality of sub-pixels further comprises:
a sixth switch transistor including a gate electrode to which a third gate signal is applied, a first electrode connected to the fourth node, and a second electrode to which an anode reset voltage is applied; and
a seventh switch transistor including a gate electrode to which the third gate signal is applied, a first electrode connected to the second node, and a second electrode to which an on bias voltage is applied.

12. A display device, comprising:
a display panel including a display area in which a plurality of data lines, a plurality of gate lines, a plurality of power lines, and a plurality of sub-pixels are disposed; and a gate driver connected to the plurality of gate lines; and a data driver connected to the data lines,
wherein the gate driver comprises:
a rendering signal generator configured to sequentially output a rendering signal;
a gate signal output circuit configured to sequentially output a gate signal; and
an output controller configured to receive the rendering signal, the gate signal, and a frequency control signal to output a pulse of the gate signal to a corresponding gate line or maintain a voltage of the corresponding gate line at a first gate voltage,
wherein each of first sub-pixels to which the pulse of the gate signal is applied from the output controller is charged with a data voltage from the data driver to update pixel data,
wherein each of second sub-pixels to which the voltage maintained at the first gate voltage is applied from the output controller is driven with a previously charged data voltage, and
wherein the plurality of sub-pixels comprise the first sub-pixels and the second sub-pixels.

13. The display device according to claim 12, wherein the display panel comprises:
a refresh pixel area in which pixel data is updated in one frame period; and
a skip pixel area in which pixel data is not updated,
wherein the refresh pixel area includes the first sub-pixels to which the pulse of the gate signal is applied from the output controller, and
wherein the skip pixel area includes the second sub-pixels to which the voltage maintained at the first gate voltage is applied from the output controller.

14. The display device according to claim 12, wherein the gate signal output circuit comprises:
a plurality of signal transfer stages connected to one or more clock wires to which one or more clock signals are applied, the plurality of signal transfer stages sequentially connected through a carry signal wire that provides a carry signal from a preceding stage to a succeeding stage among the plurality of signal transfer stages, each of the plurality of signal transfer stages configured to output a corresponding gate signal to a corresponding first output node,
wherein the output controller comprises:
a plurality of controllers, each connected to a corresponding one of the plurality of signal transfer stages of the gate signal output circuit, each of the plurality of controllers configured to receive the corresponding gate signal from a corresponding signal transfer stage, receive the frequency control signal, and output a corresponding final gate signal to a corresponding second output node connected to a respective gate line, and
wherein the corresponding final gate signal includes a pulse of the corresponding gate signal or a signal maintained at the first gate voltage.

15. The display device according to claim 12, wherein:
the gate signal output circuit comprises a plurality of signal transfer stages;
the output controller comprises a plurality of controllers;
an N-th signal transfer stage among the plurality of signal transfer stages is configured to output an N-th gate signal to a first output node in response to a voltage of a Q node;
an N-th controller among the plurality of controllers is configured to share the Q node and output an N-th final gate signal to a second output node in response to an N-th rendering signal, the N-th gate signal, and the frequency control signal; and
N is a natural number.

16. The display device according to claim 15, wherein the N-th controller comprises:
a first transistor including a gate electrode connected to the Q node, a first electrode connected to a VEL node to which the first gate voltage is applied, and a second electrode connected to the second output node;
a capacitor in which a voltage of the frequency control signal is charged;
a second transistor including a gate electrode to which the N-th rendering signal is applied, a first electrode connected to the capacitor, and a second electrode to which the frequency control signal is applied; and
a third transistor including a gate electrode connected to the capacitor, a first electrode connected to the first output node, and a second electrode connected to the second output node.

17. The display device according to claim 12, wherein each of the plurality of sub-pixels comprises:
a light-emitting device;
a driving circuit configured to drive the light-emitting device;
a capacitor connected to the driving circuit; and
one or more switch circuits connected to the capacitor.

18. The display device according to claim 17, wherein:
each of the one or more switch circuits includes a transistor; and
the pulse of the gate signal output from the output controller or the first gate voltage is applied to a gate electrode of the transistor.

19. The display device according to claim 12, wherein each of the plurality of sub-pixels comprises:
a driving transistor including a gate electrode connected to a first node, a first electrode connected to a second node, and a second electrode connected to a third node;
a light-emitting device including an anode electrode connected to a fourth node and a cathode electrode to which a cathode voltage is applied;
a capacitor connected between a node to which a pixel driving voltage is applied and the first node;
a first switch transistor including a gate electrode to which a first gate signal is applied, a first electrode connected to the first node, and a second electrode connected to the third node;
a second switch transistor including a gate electrode to which a second gate signal is applied, a first electrode connected to a data line, and a second electrode connected to the second node;
a third switch transistor including a gate electrode to which a fifth gate signal is applied, a first electrode connected to the node to which the pixel driving voltage is applied, and a second electrode connected to the second node;
a fourth switch transistor including a gate electrode to which the fifth gate signal is applied, a first electrode connected to the third node, and a second electrode connected to the fourth node;
and a fifth switch transistor including a gate electrode to which a fourth gate signal is applied, a first electrode connected to the first node, and a second electrode to which an initialization voltage is applied, and
wherein the pulse of the gate signal output from the output controller or the first gate voltage is at least one of the first gate signal and the fourth gate signal.

20. The display device according to claim 19, wherein each of the plurality of sub-pixels comprises:
a sixth switch transistor including a gate electrode to which a third gate signal is applied, a first electrode connected to the fourth node, and a second electrode to which an anode reset voltage is applied; and
a seventh switch transistor including a gate electrode to which the third gate signal is applied, a first electrode connected to the second node, and a second electrode to which an on bias voltage is applied.
